(19) United States
(12) Patent Application Publication
(10) Pub. No.: US 2022/0177659 A1
(43) Pub. Date: Jun. 9, 2022

(54) NON-CORE SHELL POLYMER PARTICLES

(71) Applicant: The University of Sydney, Sydney (AU)

(72) Inventors: Brian Stanley Hawkett, Mona Vale (AU); Duc Ngoc Nguyen, Bankstown (AU); Chiara Neto, Annandale (AU); The Vien Huynh, Kensington (AU); Timothy Warren Davey, Wheelers Hill (AU)

(21) Appl. No.: 17/600,691

(22) PCT Filed: Mar. 31, 2020
(86) PCT No.: PCT/AU20/50317

§ 371 Date: Oct. 1, 2021

(30) Foreign Application Priority Data
Apr. 1, 2019 (AU) 2019901092

(51) Int. Cl. C08J 5/18; C08F 2/38; C08F 257/02; C08F 2/20; C08F 293/00; C08F 212/08

(52) U.S. Cl. CPC C08J 5/18; C08F 2/38; C08F 257/02; C08F 2438/03; C08F 293/005; C08F 212/08; C08F 2/20

(57) ABSTRACT

The present invention relates to a method which uses non-core-shell polymer particles to form polymer film on a pre-formed solid substrate surface, said non-core-shell polymer particles comprising two covalently coupled polymer regions of different molecular composition, wherein (a) one of the two polymer regions is a crosslinked RAFT polymer region and the other polymer region is a film forming polymer region, (b) the crosslinked RAFT polymer region comprising particle aggregation prevention means selected from one or more of charged and steric stabilising functionality, and (c) the film forming polymer region comprising 0-3 wt. % of charged polymerised monomer residues relative to the total amount of polymerised monomer residues present in that region.

### FIELD OF THE INVENTION

The present invention relates in general to non-core-shell polymer particles, and in particular to a method that uses non-core-shell polymer particles to form polymer film on the surface of a pre-formed solid substrate. The invention also relates to a solid substrate having a non-core-shell polymer particle derived polymer film on a surface thereof.

### BACKGROUND OF THE INVENTION

Polymer particles are used extensively in a diverse array of applications. For example, they may be used in coatings (e.g. paint), adhesive, filler, primer, sealant, pharmaceutical, cosmetic, agricultural, explosive and diagnostic applications.

In recent years there has been increased interest in the development and use of micron or sub-micron heterogeneous polymer particles (i.e. polymer particles comprising at least two phases or regions of polymer that each have a different molecular composition).

Heterogeneous polymer particles include those having core-shell and non-core-shell structures.

Core-shell polymer particles are known in the art to comprise a substantially spherical core polymer region that is encapsulated by a shell polymer region, with the core and shell polymer regions having different molecular compositions. Such structures typically present only one exposed polymer composition, namely the shell polymer composition, with the core polymer composition being internalised by the encapsulating shell polymer.

As used herein, an “exposed” polymer composition is intended to mean a polymer composition that is adjacent to or in contact with an environment external to the polymer particles. For example, where the polymer particles are dispersed in a liquid or make contact with a solid substrate, an exposed polymer composition will be one that is directly adjacent to or can make contact with the liquid or solid substrate.

Non-core-shell polymer structures are known in the art to also comprise at least two polymer regions or phases of different molecular compositions that are associated but not in a core-shell structure. Non-core shell polymer structures therefore necessarily present at least two exposed polymer regions or phases of different molecular composition and can take a variety of physical forms.

Due to the presence of at least two exposed polymer regions or phases of different molecular composition, non-core-shell polymer structures are often referred to as anisotropic polymer particles. The anisotropic nature of such particles can give rise to asymmetric interactions.

Numerous techniques have been developed for preparing heterogeneous non-core-shell polymer structures. However, in practice it has been difficult to control the morphology, size and composition of such particles.

A particular class of non-core-shell polymer structures of emerging interest include those which present two surfaces or faces of different composition or structure (known in the art as Janus particles). Janus character is therefore a surface rather than bulk property of the particles.

Conventional techniques for preparing micron or sub-micron Janus particles often suffer from extremely low yields, thereby limiting their practical application. Techniques have been developed for producing larger quantities of Janus particles, but those generally afford relatively large particles (e.g. several microns in diameter).

Despite their unique properties, to date, owing to difficulties in their bulk manufacture, there has been limited practical research and application of such Janus particles, particularly sub-micron Janus particles.

An opportunity therefore remains to develop new applications for non-core-shell polymer particles.

### SUMMARY OF THE INVENTION

The present invention provides a method which uses non-core-shell polymer particles to form polymer film on a pre-formed solid substrate surface, said non-core-shell polymer particles comprising two covalently coupled polymer regions of different molecular composition, wherein (a) one of the two polymer regions is a crosslinked RAFT polymer region and the other polymer region is a film forming polymer region, (b) the crosslinked RAFT polymer region comprising particle aggregation prevention means selected from one or more of charged and steric stabilising functionality, and (c) the film forming polymer region comprising 0-3 wt. % of charged polymerised monomer residues relative to the total amount of polymerised monomer residues present in that region, the method comprising contacting in a liquid the pre-formed solid substrate surface with the non-core-shell polymer particles dispersed in the liquid, wherein the non-core-shell polymer particles adsorb onto the pre-formed solid substrate surface through the film forming polymer region and the film forming polymer regions of the adsorbed non-core-shell polymer particles coalesce to form the polymer film.

In one embodiment the pre-formed solid substrate is in the form of preformed solid particulate material and the non-core-shell polymer particles form an encapsulating polymer film around the pre-formed solid particulate material.

The present invention may therefore also be described as providing a method which uses non-core-shell polymer particles to form an encapsulating polymer film around pre-formed solid particulate material, said non-core-shell polymer particles comprising two covalently coupled polymer regions of different molecular composition, wherein (a) one of the two polymer regions is a crosslinked RAFT polymer region and the other polymer region is a film forming polymer region, (b) the crosslinked RAFT polymer region comprising particle aggregation prevention means selected from one or more of charged and steric stabilising functionality, and (c) the film forming polymer region comprising 0-3 wt. % of charged polymerised monomer residues relative to the total amount of polymerised monomer residues present in that region, the method comprising contacting in a liquid the pre-formed solid particulate material with the non-core-shell polymer particles dispersed in the liquid, wherein the non-core-shell polymer particles adsorb onto the pre-formed solid particulate material surface through the film forming polymer region and the film forming polymer regions of the adsorbed non-core-shell polymer particles coalesce to form the encapsulating polymer film.

In one embodiment, the film forming polymer region comprises less than 2 wt. %, or less than 1 wt. %, or less than 0.5 wt. %, or less than 0.1 wt. %, of charged polymerised monomer residues relative to the total amount of polymerised monomer residues present in that region.

In a further embodiment, the film forming polymer region comprises no charged polymerised monomer residues.

It has now surprisingly been found non-core-shell polymer particles used according to the invention can effectively and efficiently adsorb through their film forming polymer region at high density onto the surface of a substrate to form a polymer film thereon.

Without wishing to be limited by theory, it is believed a low or no charged polymerised monomer residue content in the film forming polymer region plays an important role in being able to achieve high density packing of the non-core-shell polymer particles onto the pre-formed solid substrate surface. That in turn is believed to enable the adsorbed film forming polymer regions to come into sufficient close contact to coalesce and form the polymer film.

It is particularly surprising low or no charged polymerised monomer residue content in the film forming polymer region enables the non-core-shell polymer particles to efficiently adsorb through the film forming polymer region onto the surface of the substrate.

It seems providing the non-core-shell polymer particles with just enough stabilisation to prevent aggregation when dispersed in a liquid, while minimising stabilisation of the film forming polymer region, enables high density packing of the particles onto the pre-formed solid substrate, which in turn enables coalescence of the film forming polymer regions to form the film

It is believed such use of the non-core-shell polymer particles represents a unique means of forming polymer film on substrate surfaces that is particularly amenable to scale up and industrial manufacturing processes. For example, conventional techniques for providing polymer film on a substrate surface have relied upon coating a substrate with a liquid solvated form of polymer, coating a substrate with a dispersion of conventional homogeneous polymer particles, or polymerising monomer on the surface of the substrate.

Those techniques have either little finesse, cannot be readily applied at a micron or sub-micron level and/or are complicated and present problems with achieving uniform polymer film coverage on the substrate surface.

The present invention advantageously makes use of pre-formed non-core-shell polymer particles having a unique structure. Using such pre-formed components greatly assists with scale up and the industrial application of the invention.

The non-core-shell polymer particles can advantageously form a uniform polymer film with precise control on small sub-micron substrates without the need to apply a polymerisation process as part of the film forming step.

In one embodiment, the non-core-shell polymer particles adsorb onto the pre-formed solid substrate surface through the film forming polymer region in two or more layers and the film forming polymer regions of the adsorbed non-core-shell polymer particles coalesce to form a multilayer polymer film.

In one embodiment, the non-core-shell polymer particles have a largest average diameter of no more than about 5 microns, or no more than about 1 micron, or no more than about 700 nm, or no more than about 500 nm, or no more than about 300 nm, or no more than about 200 nm, or no more than about 100 nm, or no more than about 70 nm, or no more than about 50 nm, or no more than about 30 nm, or no more than about 10 nm.

In another embodiment, the non-core-shell polymer particles have a largest average diameter ranging from about 10 nm to about 5 microns, or from about 10 nm to about 1 microns, or from about 10 nm to about 700 nm, or from about 10 nm to about 500 nm, or from about 10 nm to about 300 nm, or from about 10 nm to about 200 nm, or from about 10 nm to about 100 nm, 10 nm to about 70 nm, 10 nm to about 50 nm, 10 nm to about 30 nm.

The size of the non-core-shell polymer particles used will typically depend on the size of the preformed solid substrate to be coated. Those skilled in the art can readily select a suitable size for the non-core-shell polymer particles for a given preformed solid substrate.

The present invention also provides use of non-core-shell polymer particles dispersed in a liquid to form polymer film on a pre-formed solid substrate surface, said non-core-shell polymer particles comprising two covalently coupled polymer regions of different molecular composition, wherein (a) one of the two polymer regions is a crosslinked RAFT polymer region and the other polymer region is a film forming polymer region, (b) the crosslinked RAFT polymer region comprising particle aggregation prevention means selected from one or more of charged and steric stabilising functionality, and (c) the film forming polymer region comprising 0-3 wt. % of charged polymerised monomer residues relative to the total amount of polymerised monomer residues present in that region.

The present invention further provides use of non-core-shell polymer particles dispersed in a liquid to form an encapsulating polymer film around pre-formed solid particulate material, said non-core-shell polymer particles comprising two covalently coupled polymer regions of different molecular composition, wherein (a) one of the two polymer regions is a crosslinked RAFT polymer region and the other polymer region is a film forming polymer region, (b) the crosslinked RAFT polymer region comprising particle aggregation prevention means selected from one or more of charged and steric stabilising functionality, and (c) the film forming polymer region comprising 0-3 wt. % of charged polymerised monomer residues relative to the total amount of polymerised monomer residues present in that region.

In one embodiment, the so formed polymer film is a multi-layer polymer film.

The present invention still further provides solid substrate having polymer film adsorbed on a surface thereof, said polymer film comprising a plurality of polymer regions that (i) are different in molecular composition to the polymer film, (ii) are covalently coupled to the polymer film, and (iii) comprise (a) crosslinked RAFT polymer, and (b) particle aggregation prevention means selected from one or more of charged and steric stabilising functionality, wherein said polymer film comprises 0-3 wt. % of charged polymerised monomer residues relative to the total amount of polymerised monomer residues present in the film.

The present invention also provides solid particulate material encapsulated in a polymer film, said polymer film comprising a plurality of polymer regions that (i) are different in molecular composition to the polymer film, (ii) are covalently coupled to the polymer film, and (iii) comprise (a) crosslinked RAFT polymer, and (b) particle aggregation prevention means selected from one or more of charged and steric stabilising functionality, wherein said polymer film comprises 0-3 wt. % of charged polymerised monomer residues relative to the total amount of polymerised monomer residues present in the film.

Where the polymer film is a multi-layer polymer film it will be appreciated the plurality of polymer regions that (i) are different in molecular composition to the polymer film, (ii) are covalently coupled to the polymer film, and (iii) comprise crosslinked RAFT polymer, will be embedded within the multilayer structure of the film.

In one embodiment, the crosslinked RAFT polymer region, or the plurality of polymer regions that (i) are different in molecular composition to the polymer film, (ii) are covalently coupled to the polymer film, and (iii) comprise crosslinked RAFT polymer, comprise a higher wt. % of charged polymerised monomer residues than the film forming polymer region.

In another embodiment, the crosslinked RAFT polymer region comprises 0 wt. % to 90 wt. %, 0 wt. % to 60 wt. %, 0 wt. % to 40 wt. %, 0 wt. % to 30 wt. %, 0 wt. % to 20 wt. %, 0 wt. % to 10 wt. % of charged polymerised monomer residues, relative to the total amount of polymerised monomer residues present in that region.

In one embodiment, the film forming polymer region or film derived therefrom does not comprise particle aggregation prevention means selected from one or more of charged and steric stabilising functionality.

Further aspects and embodiments of the invention are discussed in more detail below.

### BRIEF DESCRIPTION OF THE DRAWINGS

Preferred embodiments of the invention will now be illustrated by way of example only with reference to the accompanying non-limiting drawings in which:

FIG. 1 is an illustration of non-core-shell polymer particles used in accordance with the invention;

FIG. 2 is an illustration of non-core-shell polymer particles used in accordance with the invention forming polymer film on a preformed solid substrate surface;

FIG. 3 presents a schematic illustration steps that may be followed to prepare non-core-shell polymer particles used in accordance with the invention;

FIG. 4 illustrates R706 Titanium dioxide coated with polymer non-core-shell polymer particles according to Example 2a;

FIG. 5 illustrates Omyacarb 10 coated with polymer non-core-shell polymer particles according to Example 8a; and

FIG. 6 illustrates Omyacarb 10 coated with polymer non-core-shell polymer particles according to Example 8b.

### DETAILED DESCRIPTION OF THE INVENTION

The present invention uses non-core-shell polymer particles comprising two covalently coupled polymer regions of different molecular composition, wherein (a) one of the two polymer regions is a crosslinked RAFT polymer region and the other polymer region is a film forming polymer region, (b) the crosslinked RAFT polymer region comprises particle aggregation prevention means selected from one or more of charged and steric stabilising functionality, and (c) the film forming polymer region comprises 0-3 wt. % of charged polymerised monomer residues relative to the total amount of polymerised monomer residues present in that region.

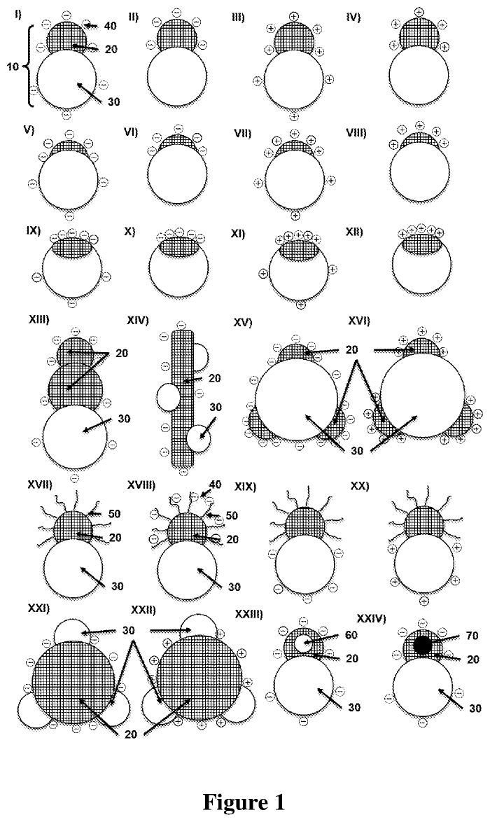

Provided the polymer particles exhibit typical non-core-shell characteristics, there is no particular limitation on the specific shape/morphology of the particles. For example, the non-core-shell polymer particles used according to the invention may have a form schematically represented in FIG. 1. In FIG. 1, non-core-shell polymer particles (10) as shown in (I)-(XXIV) present a crosslinked RAFT polymer region (20) that is covalently coupled to a film forming polymer region (30). The crosslinked RAFT polymer region (20) comprises particle aggregation prevention means selected from one or more of charged (positive or negative) functionality (40) and steric stabilising functionality (50). The film forming polymer region (30) comprises 0-3 wt. % of charged polymerised monomer residues relative to the total amount of polymerised monomer residues present in that region, where present represented as positive or negative charged functionality (40). The crosslinked RAFT polymer region (20) may comprise one or more voids (60) or particulate material, such as a pigment particle(s), (70).

In one embodiment, the non-core-shell polymer particles have a largest average diameter of no more than about 5 microns, or no more than about 1 micron, or no more than about 700 nm, or no more than about 500 nm, or no more than about 300 nm, or no more than about 200 nm, or no more than about 100 nm, or no more than about 70 nm, or no more than about 50 nm, or no more than about 30 nm, or no more than about 10 nm.

In another embodiment, the non-core-shell polymer particles have a largest average diameter ranging from about 10 nm to about 5 microns, or from about 10 nm to about 1 microns, or from about 10 nm to about 700 nm, or from about 10 nm to about 500 nm, or from about 10 nm to about 300 nm, or from about 10 nm to about 200 nm, or from about 10 nm to about 100 nm, 10 nm to about 70 nm, 10 nm to about 50 nm, 10 nm to about 30 nm.

While the non-core-shell polymer particles can have a spherical shape, the may also have an elongated of rod-like shape.

In one embodiment, the non-core-shell polymer particles are spherical in shape.

In one embodiment, the non-core-shell polymer particles are elongated or rod-like in shape.

The size and shape of the non-core-shell polymer particles can be readily determined by an appropriate form of microscopy, for example scanning electron microscopy (SEM) or transmission electron microscopy (TEM)

The crosslinked RAFT polymer region is a region of crosslinked RAFT polymerisation derived polymer chains. Due to being crosslinked, the RAFT polymer region will typically not be film forming. In preparing the non-core-shell polymer particles (discussed below), the crosslinked RAFT polymer region is typically formed first and functions as seed from which to grow the film forming polymer region. Without wishing to be limited by theory, it is believed preparing the non-core-shell polymer particles using a crosslinked RAFT polymer region (seed) enables the polymer particles to be prepared with excellent control over size, shape and surface characteristics. Furthermore, the non-core-shell polymer particles can be prepared using little if no conventional surfactant. That in turn makes the so formed polymer particles well suited for use according the present invention.

The non-core-shell polymer particle may have two or more crosslinked RAFT polymer regions.

The non-core-shell polymer particle may have two or more film forming polymer regions.

Provided the non-core-shell polymer particles present sufficient film forming polymer region to enable a polymer film to be formed according to the invention, there is no particular limitation on the amount of film forming polymer region provided in a given non-core-shell polymer particle.

Generally the film forming polymer region(s) will be present in an amount ranging from 5 to 95 wt. %, or 10 to 95 wt. %, or 15 to 95 wt. %, or 20 to 95 wt. %, or 30 to 95 wt. %, or 40 to 95 wt. %, or 50 to 95 wt. %, relative to total mass of polymer that makes up a non-core-shell polymer particle.

Generally the crosslinked RAFT polymer region(s) will be present in an amount ranging from 5 to 95 wt. %, or 10 to 95 wt. %, or 15 to 95 wt. %, or 20 to 95 wt. %, or 30 to 95 wt. %, or 40 to 95 wt. %, or 50 to 95 wt. %, relative to total mass of polymer that makes up a non-core-shell polymer particle.

Where two or more film forming or crosslinked polymer regions are present in a given non-core-shell polymer particle, the aforementioned wt. % amounts will relate to the sum of the two or more respective regions.

An important feature of the non-core-shell polymer particles is the film forming polymer region. By that region being “film forming” is meant the region is capable of coalescing with other such regions to form polymer film. The concept of film forming particles (regions) that coalesce to form polymer film is well known and understood in the art.

The film forming polymer region may be film forming by virtue of the polymer region having a glass transition temperature (Tg) below the temperature at which the invention is performed. For example, where the invention is performed at 25° C., the Tg of the film forming polymer region would typically be less than about 20° C. Those skilled in the art will be able to select a suitable Tg for a given film forming polymer region such that polymer film can be formed at the required temperature.

Reference herein to Tg is intended to mean Fox Tg.

The film forming polymer region may be film forming by virtue of its Tg and/or the use of a coalescing agent. Those skilled in that art will appreciate polymer having a Tg higher than a nominated temperature can nevertheless be made film forming using a coalescing agent. Examples of common coalescing agents include, but are not limited to, hexane, heptane, octane, cyclohexane, methanol, ethanol, propylene glycol, toluene, xylene, tetrahydrofuran, dichoromethane, dibutyl phthalte and trade products such as Texanol™ and Optifilm™.

According to the present invention, the non-core-shell polymer particles adsorb onto the pre-formed solid substrate surface through the film forming polymer region and the film forming polymer regions of the adsorbed non-core-shell polymer particles coalesce to form the polymer film.

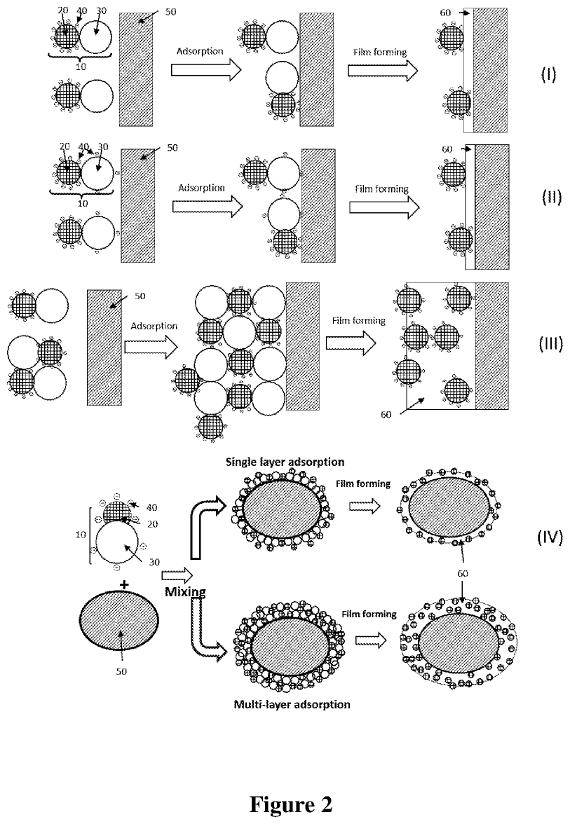

The ability of the non-core-shell polymer particles to adsorb at high density onto the pre-formed solid substrate and form polymer film thereon is a unique feature of the invention. The film forming process is schematically represented in FIG. 2.

With reference to FIG. 2, the non-core-shell polymer particles (10) present a crosslinked RAFT polymer region (20) that is covalently coupled to a film forming polymer region (30). The crosslinked RAFT polymer region (20) in FIG. 2 comprises particle aggregation prevention means in the form of charged (positive or negative) functionality (40). The film forming polymer region (30) comprises 0-3 wt. % of charged polymerised monomer residues relative to the total amount of polymerised monomer residues present in that region, where present represented as positive or negative charged functionality (40). The non-core-shell polymer particles (10) can adsorb through film forming polymer region (30) onto a surface of a pre-formed solid substrate (50). Once adsorbed, the film forming polymer regions of the adsorbed non-core-shell polymer particles coalesce to form the polymer film (60). The non-core-shell polymer particles may be adsorbed through their film forming polymer regions in various orientations, as shown in FIG. 2.

FIG. 2, parts (I) and (II) illustrate the formation of a single polymer film layer.

FIG. 2, part (III) illustrates the formation of multiple polymer film layers.

FIG. 2, part (IV) illustrates the formation of a single encapsulating polymer film layer (top) and the formation of multiple encapsulating polymer film layers (bottom).

The non-core-shell polymer particles used according to the invention can advantageously adsorb onto the pre-formed solid substrate in sufficient high density to enable the adsorbed film forming polymer regions of the non-core-shell polymer particle to make contact, coalesce and form polymer film. In the context of the present invention, the so formed polymer film is intended to be a continuous polymer film. That polymer film can therefore advantageously coat a surface of, or even encapsulate the entire, pre-formed solid substrate.

Two or more layers of the non-core-shell polymer particles can advantageously adsorb onto the pre-formed solid substrate, one on top of the other, thereby forming a multilayer polymer film. In that way, relatively thick polymer film can advantageously be formed.

Due to the ability to afford multi-layer film structures, there is no particular limitation on the polymer film thickness than can be produced according to the invention.

The so formed polymer film may, for example, have a thickness ranging from about 10 nm to about 500 microns, or about 10 nm to about 100 microns, or about 10 nm to about 50 microns.

In one embodiment, the so formed polymer film has a thickness ranging from about 10 nm to about 10 microns.

In another embodiment, the so formed polymer film has a thickness ranging from about 10 microns to about 300 microns.

Without wishing to be limited by theory, the ability for the non-core-shell polymer particles to adsorb at high density on the pre-formed solid substrate surface is believed to stem at least in part from the non-core-shell morphology and its unique distribution of particle aggregation prevention means. The crosslinked RAFT polymer region comprises particle aggregation prevention means selected from one or more of charged and steric stabilising functionality. The particle aggregation prevention means provided by that region facilitates dispersion of the non-core-shell polymer particles in the liquid, for example an aqueous liquid. The film forming polymer region comprises 0-3 wt. % of charged polymerised monomer residues (which, when present, can function to also prevent particle aggregation) relative to the total amount of polymerised monomer residues present in that region. The film forming polymer region may not comprise any charged polymerised monomer residues or steric stabilising functionality. Nevertheless, the non-core-shell polymer particles are sufficiently stabilised to be dispersed in the liquid.

In other words, the non-core-shell polymer particles are sufficiently stabilised to be dispersed in the liquid, but that effect is achieved with minimising any particle aggregation prevention means associated with the film forming polymer region. Charge provided by polymerised monomer residues has been found to be quite influential not only in terms of preventing aggregation of particles in a liquid, but also in terms of preventing close packing of the polymer particles on a substrate surface. The film forming polymer region of the non-core-shell polymer particles according to the invention therefore comprise only from 0-3 wt. % of charged polymerised monomer residues.

Conventional means for promoting polymer particles to adsorb on the surface of a solid substrate typically rely on the polymer particles and the solid substrate surface having substantial charge, often opposite charge to each other.

Despite the film forming polymer region, being the region that adsorbs onto the solid substrate surface, having little or no charge derived from polymerised monomer residues, it has surprisingly been be found the non-core-shell polymer particles not only can remain dispersed in a liquid, but can still effectively adsorb onto the surface of solid substrates.

Furthermore, by minimising particle aggregation prevention means associated with the film forming polymer region it is believed those regions, upon adsorbing to the solid substrate surface, can pack close together thereby promoting contact and subsequent coalescence to form polymer film. That is in contrast with conventional techniques for adsorbing polymer particles onto a solid substrate surface where a relatively high level of charge on the polymer particles is used to promote not only dispersion in a liquid but also binding to the substrate surface. While that high level of charge facilitates dispersion in a liquid and adsorption to the substrate surface it also prevents aggregation or close packing of the polymer particles on the substrate surface. That in turn prevents coalescence of any film forming polymer and formation of a polymer film. Unlike in the present invention the adsorbed polymer particles in that instance therefore present like “pimples” on the surface of the substrate.

By the crosslinked RAFT polymer region comprising particle aggregation prevention means is intended to convey that region has associated with it functionality that will assist preventing the particles from aggregating when at least dispersed in a liquid. According to the present invention, the particle aggregation prevention means is selected from one or more of charged and steric stabilising functionality.

The charged stabilising functionality may, for example, be derived from one or more of initiator and polymerised monomer residues. By the stabilising functionality being “charged” is meant it bears a positive or negative charge. For example, in the case of charged polymerised monomer residue, the polymerised monomer residue will bear a positive or negative charge. Those skilled in the art will appreciate the polymerisation process used to form the non-core-shell polymer particles may provide for such charged stabilising functionality through residues provided from either initiator or monomer. The charge may present as a positive or negative charge. Where charged stabilising functionality is present in both the crosslinked RAFT polymer region and film forming polymer region, the polarity of that charge will typically be the same (i.e. either positive or negative). Those skilled in the art can readily select a suitable charge (i.e. positive or negative) for a given application.

In one embodiment, the charged stabilising functionality presents a negative charge.

In another embodiment, the charged stabilising functionality presents a positive charge.

In a further embodiment, the film forming polymer region does not comprise charged stabilising functionality derived from polymerised monomer residue.

In another embodiment, the film forming polymer region does not comprise steric stabilising functionality.

Where charged stabilising functionality is provided by polymerised monomer residues, it will typically be derived from monomer used to prepare the relevant region (i.e. the crosslinked RAFT and the film forming polymer regions). As will be discussed in more detail below, ethylenically unsaturated monomers are typically used to prepare the non-core-shell polymer particles. To provide the required charge, ethylenically unsaturated monomers used will be ionisable.

By the term “ionisable” used in connection with ethylenically unsaturated monomers or a group or region formed using such monomers is meant the monomer, group or region is/has a functional group(s) which can be ionised to form a cationic (positive) or anionic group (negative). Such functional groups will generally be capable of being ionised under acidic or basic conditions through loss or acceptance of a proton. Generally, the ionisable functional groups are acid groups or basic groups. For example, a carboxylic acid functional group may form a carboxylate anion under basic conditions, and an amine functional group may form a quaternary ammonium cation under acidic conditions. The functional groups may also be capable of being ionised through an ion exchange process.

By the term “non-ionisable” used in connection with ethylenically unsaturated monomers or a group or region formed using such monomers is meant the monomer, group or region does not have ionisable functional groups. In particular, such monomers, groups or regions do not have acid groups or basic groups which can lose or accept a proton under acidic or basic conditions.

While the film forming polymer region can only comprise 0-3 wt. % of charged polymerised monomer residues, that region may also comprise some ionisable monomer residue that is not in a charged state. For example, the film forming polymer region may comprise 10 wt. % of ionisable polymerised monomer residues, relative to the total amount of polymerised monomer residues in that region, where only 30% of the 10 wt. % of monomer residues present in a charged state (providing for the upper limit of 3 wt. % of charged polymerised monomer residues). The ability to control the proportion of ionisable polymerised monomer residues that convert into a charged state will of course depend on the pH environment to which they are exposed. Where more than 3 wt. % of ionisable polymerised monomer residues are present those skilled in the art will be able to control the degree of ionisation by pH manipulation to provide for the required 0-3 wt. % of charged polymerised monomer residues.

Having said that, it may be desirable to minimise the presence of ionisable polymerised monomer residues in the film forming polymer region, whether they are in a charged state or not. Having ionisable polymerised monomer residues in the film forming polymer region imparts those residues into the so formed film. The resulting polymer film may then become susceptible to water sensitivity that may be undesirable in certain applications.

In one embodiment, the film forming polymer region comprises 0-10 wt. %, or 0-8 wt. %, or 0-6 wt. %, or 0-5 wt. %, or 0-4 wt. %, or 0-3 wt. % of ionisable polymerised monomer residues, relative to the total amount of polymerised monomer residues present in that region.

Where the film forming polymer region comprises greater than 3 wt. % of ionisable polymerised monomer residues, the liquid in which the non-core-shell polymer particles are dispersed will generally have a pH of no more than 5, or no more than 4 or no more than 3. For example, the pH may range from 3-5, or 3-4. Such an acidic pH range will enable suitable adjustment of the amount of ionisable polymerised monomer residues that are ionised to form a charge.

In one embodiment, the liquid in which the non-core-shell polymer particles are dispersed has a pH in the range of 3-5 or 3-4.

The crosslinked RAFT polymer region may comprise 0 wt. % to 90 wt. %, 0 wt. % to 60 wt. %, 0 wt. % to 40 wt. %, 0 wt. % to 30 wt. %, 0 wt. % to 20 wt. %, 0 wt. % to 10 wt. % of ionisable polymerised monomer residues or charged polymerised monomer residues, relative to the total amount of polymerised monomer residues present in that region.

As the crosslinked RAFT polymer region will typically not form polymer film according to the invention, it does not have the same water sensitive issues relative to the film forming polymer region. Nevertheless, it may still be desirable to minimise the amount of ionisable polymerised monomer residues, and hence charged polymerised monomer residues, present in the crosslinked RAFT polymer. For example, the crosslinked RAFT polymer region may comprise 0 wt. % to 20 wt. %, 0 wt. % to 10 wt. %, 0 wt. % to 7 wt. %, 0 wt. % to 5 wt. %, or 0 wt. % to 3 wt. % ionisable polymerised monomer residues or charged polymerised monomer residues, relative to the total amount of polymerised monomer residues present in that region.

Examples of ionisable ethylenically unsaturated monomers which have acid groups (and can provide for negative charge) include, but are not limited to, methacrylic acid, acrylic acid, itaconic acid, p-styrene carboxylic acids, p-styrene sulfonic acids, vinyl sulfonic acid, vinyl phosphonic acid, ethacrylic acid, alpha-chloroacrylic acid, crotonic acid, fumaric acid, citraconic acid, mesaconic acid and maleic acid.

Examples of ionisable ethylenically unsaturated monomers which have basic groups (and can provide for positive charge) include, but are not limited to, 2-(dimethyl amino) ethyl and propyl acrylates and methacrylates, and the corresponding 3-(diethylamino) ethyl and propyl acrylates and methacrylates, diallyldimethyl ammonium halide, triallymethyl ammonium halide, vinylalkylpyrrolidinium halide, vinylpyrrolidone, allylalkylpyrrolidionium halide and diallylpyrrolidinium halide.

Where the charged stabilising functionality is provided by initiator residue, those skilled in the art will be able to select a suitable initiator for use when making the non-core-shell polymer particles. By way of example only, examples of imitators that can provide charge include, but are not limited to, those that provide negative charge such as 4,4′-azobis(4-cyanovaleric acid), potassium peroxydisulfate, ammonium peroxydisulfate, or those that provide positive charge such as 2,2′-azobis{2-methyl-N-[1,1-bis(hydroxymethyl)-2-hydroxyethyl]propionamide}, 2,2′-azobis[2-methyl-N-(2-hydroxyethyl)propionamide], 2,2′-azobis(N,N′-dimethyleneisobutyramidine) dihydrochloride, 2,2′-azobis(2-amidinopropane) dihydrochloride, 2,2′-azobis(N,N′-dimethyleneisobutyramidine), 2,2′-azobis{2-methyl-N-[1,1-bis(hydroxymethyl)-2-hydroxyethyl]propionamide}, 2,2′-azobis{2-methyl-N-[1,1-bis(hydroxymethyl)-2-ethyl]propionamide}, 2,2′-azobis[2-methyl-N-(2-hydroxyethyl)propionamide], and 2,2′-azobis(isobutyramide) dihydrate.

Those skilled in the art will appreciate the wt. % of charged polymerised monomer residues in a given region of the non-core-shell polymer particles will be derived from the wt. % of ionisable monomers used to prepare that polymer region. Equally, the total amount of polymerised monomer residues present in or that make up that region corresponds to the total wt. % of all monomers used to prepare the polymer region.

In one embodiment, the film forming polymer region comprises less than 2 wt. %, or less than 1 wt. %, or less than 0.5 wt. %, or less than 0.1 wt. %, of charged polymerised monomer residues relative to the total amount of polymerised monomer residues present in that region.

In a further embodiment, the film forming polymer region comprises no charged polymerised monomer residues.

Having regard to the fact an ionisable polymerised monomer residue may be present in a polymer region, but not in a charged state, in describing at least the polymerised monomer residue content of a given polymer region it can sometimes be convenient to refer to the charged polymerised monomer residues as ionisable polymerised monomer residues (ie. where at the point in time of making the polymer region the ionisable polymerised monomer residues are not yet in a charged state.

The crosslinked RAFT polymer region may and generally will comprise a higher wt. % of charged polymerised monomer residues than the film forming polymer region.

In one embodiment, the crosslinked RAFT polymer region comprises a higher wt. % of charged polymerised monomer residues compared to the film forming polymer region.

Steric stabilising functionality may be provided by polymeric moieties such as polyethylene glycols, polyacrylates and polyacrylamides. Those polymeric moieties may be provided to a given polymer region through polymerised macromere or monomer residues such as polyethylene glycol (meth)acrylate and hydroxyethyl (meth) acrylate.

Provided the non-core-shell polymer particles can be dispersed in the liquid, there is no particular limitation on the nature of that liquid. The liquid may be an organic or aqueous liquid. Where the liquid is an aqueous liquid it may contain one or more water miscible solvents.

In one embodiment, the liquid within which the non-core-shell polymer particles are dispersed is an aqueous liquid.

In accordance with the invention the non-core-shell polymer particles form polymer film on a pre-formed solid substrate surface. By a “pre-formed” solid substrate (surface) is meant a solid substrate has not been formed/manufactured in the presence of the non-core-shell polymer particles, but rather has been formed/manufactured prior to having any contact with the non-core-shell polymer particles.

By the pre-formed solid substrate being “solid” is meant at least solid at the temperature at which the invention is performed. Generally, the pre-formed solid substrate will be solid at room temperature (25° C.).

Provided the non-core-shell polymer particles can adsorb on a surface of the pre-formed solid substrate as described herein there is no particular limitation on the size/shape of the substrate or the material from which it is made. For example, the pre-formed solid substrate may be in sheet, block, film, fibre or particulate form.

In some embodiments the pre-formed solid substrate is in the form of preformed solid particulate material. The particulate material may be in the form of primary particles, or in the form of an aggregation of primary particles.

Those skilled in the art will appreciate that as the size of particulate materials decrease, the degree of difficulty in being able to deposit polymer film in a controllable manner at the surface of the materials typically increases. The unique method of the invention advantageously enables polymer film to be formed in a controlled manner with relative ease at the surface of both small and large particles alike, be they primary particles or aggregates thereof.

Provided the non-core-shell polymer particles can adsorb on a surface of the particulate material, the preformed solid particulate material may be of any type, shape or size.

In one embodiment, the preformed solid particulate material has a largest average diameter of no more than about 300 microns, or no more than about 100 microns, or no more than about 50 microns, or no more than about 10 microns, or no more than about 500 nm, or no more than about 300 nm, or no more than about 200 nm, or no more than about 100 nm, or no more than about 60 nm, or no more than about 20 nm.

In another embodiment, the preformed solid particulate material has a largest average diameter ranging from about 20 nm to about 300 microns, or from about 20 nm to about 100 microns, or from about 20 nm to about 50 microns, or from about 20 nm to about 500 nm, or from about 20 nm to about 300 nm, or from about 20 nm to about 100 nm, or from about 50 nm to about 100 microns, or from about 100 nm to about 100 microns, or from about 100 nm to about 50 microns.

Suitable substances from which the pre-formed solid substrate may comprise or be made of include, but are not limited to inorganic, organic, metal, glass and ceramic material. The pre-formed solid substrate may comprise or be made of, for example, titanium dioxide, zinc oxide, calcium carbonate, iron oxide, zirconium silicate, silicon dioxide, barium sulfate, carbon black, phthalocyanine blue, phthalocyanine green, quinacridone and dibromananthrone, magnetic material such as y-iron oxide, carbon nanotubes, graphene, graphene oxide, reduced graphene oxide, terracotta, wax, alumina, carbon fibre and concrete.

In one embodiment the pre-formed solid substrate comprises or is made of pigment material. Examples of inorganic pigment material include, but are not limited to, titanium dioxide, zinc oxide, calcium carbonate, iron oxide, silicon dioxide, barium sulfate and carbon black. Examples of organic pigment material include, but are not limited to, phthalocyanine blue, phthalocyanine green, quinacridone and dibromananthrone.

In another embodiment the pre-formed solid substrate comprises or is made of a chemical reagent. Examples of chemical reagents include, but are not limited to, polymerisation initiators (for example, such as free radical initiators described herein) and fire retardants (for example, triphenyl phosphate).

In a further embodiment the pre-formed solid substrate comprises or is made of bioactive material. Examples of bioactive material include, but are not limited to, yeast, pharmaceuticals and agrochemicals.

Examples of agrochemicals includes pesticides, for example, insecticides, fungicides, herbicides, rodenticides, nematicides, acaricides, and molluscicides, fertilisers, plant growth regulators, soil conditioners.

Examples of bioactive materials include, but is not limited to, benzisithiazoline, sedaxane, chlorothalonil, cyprodinil, and thiamethoxam.

The non-core-shell polymer particles used in accordance with the invention can be prepared by any suitable means.

For example, the non-core-shell polymer particles may be prepared as outlined in WO 2010/096867.

According to WO 2010/096867 non-core-shell polymer particles can be prepared by a method that includes two polymerisation stages whereby in a first stage monomer is polymerised and resulting polymer chains crosslinked to form crosslinked seed polymer particles, and in a second stage monomer is polymerised on the surface of the crosslinked seed particles. The polymer formed on the surface of the crosslinked seed particles has a different molecular composition to that of the seed particles. By controlling the manner in which the monomer swollen crosslinked seed polymer particles expel monomer, the method can advantageously be used to prepare non-core-shell polymer particles.

Increasing the temperature of the monomer swollen crosslinked seed polymer particles expels at least some of the monomer therein only onto a proportion of the surface of the particles, and polymerisation of at least the expelled monomer results in the formation of non-core-shell polymer particles.

The method of preparing non-core-shell polymer particles outlined in WO 2010/096867 comprises:
(i) providing a dispersion comprising a continuous aqueous phase, a dispersed organic phase comprising one or more ethylenically unsaturated monomers, and a RAFT agent as a stabiliser for said organic phase;
(ii) polymerising the one or more ethylenically unsaturated monomers under the control of the RAFT agent to form an aqueous dispersion of seed polymer particles;
(iii) crosslinking the seed polymer particles;
(iv) swelling the crosslinked seed particles with one or more ethylenically unsaturated monomers to form an aqueous dispersion of monomer swollen crosslinked seed polymer particles;
(v) increasing the temperature of the monomer swollen crosslinked seed polymer particles to expel at least some of the monomer therein onto only a proportion of the surface of the particles; and
(vi) polymerising at least the expelled monomer to form the non-core-shell particles.

Crosslinking of the seed polymer particles may take place simultaneously with the seed particles being formed (i.e. steps (ii) and (iii) occur simultaneously).

Crosslinking of the seed polymer particles may also take place after the seed particles have been formed (i.e. steps (ii) and (iii) occur separately).

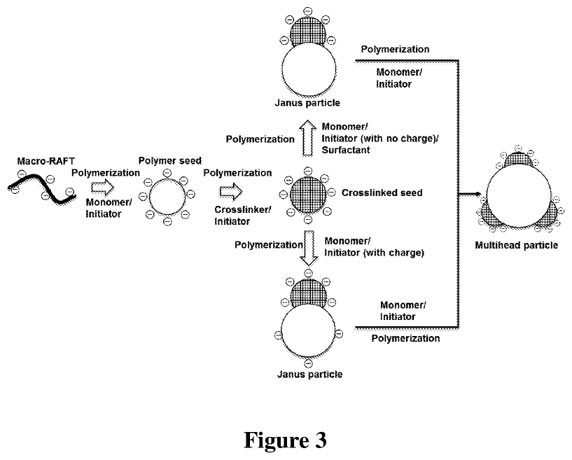

The non-core-shell polymer particles may also be prepared as outlined in a thesis titled Synthesis of Polymeric Janus Nanoparticles through Seeded Emulsion Polymerisation by Azniwati Abd Aziz, The University of Sydney, December, 2015. An example of the synthetic methodology outlined in the thesis is schematically illustrated in FIG. 3.

With reference to FIG. 3, a RAFT polymer surfactant is prepared which forms micelles. Monomer (e.g. styrene) is introduced and polymerised under the control of the RAFT polymer to form RAFT polymer seed particles that are crosslinked. Such crosslinked RAFT polymer seed particles are similar to those outlined in WO 2010/096867. Monomer is then continuously added to the RAFT polymer seed particle composition which polymerises to form a second polymer region covalently coupled to the RAFT polymer seed particle giving rise to non-core-shell polymer particles. Variation of the monomer feed may provide the film forming polymer region with or without charged polymerised monomer residue. The synthetic methodology outlined in that thesis has many similarities to that outlined in WO 2010/096867 except the second polymer region that is covalently coupled to the RAFT polymer seed particle is formed through the continuous addition of monomer rather than using the monomer expulsion approach adopted in WO 2010/096867

The synthetic methods for preparing the non-core-shell polymer particles outlined in WO 2010/096867 and the thesis can advantageously be readily scaled to produce bulk quantities of the non-core-shell polymer particles.

The non-core-shell polymer particles produced are capable of being dispersed in a liquid.

The non-core-shell polymer particles may derive the ability to be dispersed in the liquid through various means. For example, the crosslinked RAFT polymer region comprises particle aggregation prevention means selected from one or more of charged and steric stabilising functionality. The film forming polymer region also comprises 0-3 wt. % of charged polymerised monomer residues relative to the total amount of polymerised monomer residues present in that region. Where the film forming polymer region does not comprise charged polymerised monomer residues, to maintain the non-core-shell polymer particles dispersed in a liquid it may be necessary for the film forming polymer region to have associated with it some form of secondary particle aggregation prevention means. If such secondary particle aggregation prevention means is required, it will only be used in the minimum amount required to achieve dispersion of the non-core-shell polymer particles in the liquid. For example, stabilisation of the dispersion may be achieved through one or both of initiator residues as herein described and use of a surfactant.

If a surfactant is used, it will typically be used at or less than its critical micelle concentration (CMC). For example, it may be used at no more than its CMC, or no more than 0.5 of its CMC, or no more than 0.25 of its CMC.

Examples of suitable surfactants include sodium dodecyl sulfate, nonyl phenol ethoxylate sulfate, alkyl ethoxylate sulfates, alkyl sulfonates, alkyl succinates, alkyl phosphates, alkyl carboxylates, and other alternatives well known to those skilled in the art.

One or both of the crosslinked RAFT polymer region and the film forming polymer region may have covalently bound to its surface RAFT polymer chains that function as a stabiliser for the particles when they are dispersed in the liquid.

The non-core-shell polymer particles used in accordance with the invention can advantageously be prepared using conventional dispersion polymerisation techniques (e.g. conventional emulsion, mini-emulsion and suspension polymerisation) and equipment.

Such methods may comprise providing a dispersion having a continuous aqueous phase, a dispersed organic phase comprising one or more ethylenically unsaturated monomers, and a RAFT agent as a stabiliser for the organic phase.

The dispersion may be simplistically described as an aqueous phase having droplets of organic phase dispersed therein. In this context, the term “phase” is used to convey that there is an interface between the aqueous and organic media formed as a result of the media being substantially immiscible.

In isolation, it will be appreciated that the aqueous and organic phases will typically be an aqueous and organic medium (e.g. liquid), respectively. In other words, the term “phase” simply assists with describing these media when provided in the form of a dispersion.

However, for convenience the aqueous and organic media used to prepare the dispersion may hereinafter simply be referred to as the aqueous and organic phases, respectively.

In addition to the organic phase and a RAFT agent, the continuous aqueous phase may comprise one or more other components. For example, the aqueous phase may also comprise one or more aqueous soluble solvents and one or more additives such as those that can regulate and/or adjust pH.

In addition to the one or more ethylenically unsaturated monomers, the dispersed organic phase may comprise one or more other components. For example, the dispersed organic phase may also comprise one or more solvents that are soluble in the monomers, and/or one or more plasticisers. Solvent soluble in the monomer may act as a plasticiser.

As will be discussed in more detail below, the one or more ethylenically unsaturated monomers in the dispersed organic phase may be polymerised to form seed polymer particles. The seed polymer particles will typically be crosslinked. Provided crosslinked seed polymer particles can be formed, there is no particular limitation on the type of ethylenically unsaturated monomers that may be used.

Suitable ethylenically unsaturated monomers that may be used in preparing the non-core shell polymer particles are those which can be polymerised by a free radical process. The monomers should also be capable of being copolymerised with other monomers. The factors which determine copolymerisability of various monomers are well documented in the art. For example, see: Greenlee, R. Z., in Polymer Handbook 3^{rd} Edition (Brandup, J., and Immergut. E. H. Eds) Wiley: New York, 1989 p II/53. Such monomers include those with the general formula (I):

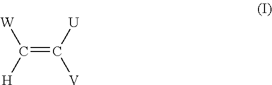

where U and W are independently selected from the group consisting of —CO₂H, —CO₂R¹, —COR¹, —CSR¹, —CSOR¹, —COSR¹, —CONH₂, —CONHR¹, —CONR¹², hydrogen, halogen and optionally substituted C₁-C₄ alkyl, or U and W form together a lactone, anhydride or imide ring that may itself be optionally substituted, wherein the substituents are independently selected from the group consisting of hydroxy, —CO₂H, —CO₂R¹, —COR¹, —CSR¹, —CSOR¹, —COSR¹, —CN, —CONH₂, —CONHR¹, —CONR¹², —OR¹, —SR¹, —O₂CR¹, —SCOR¹, and —OCSR¹; and
V is selected from the group consisting of hydrogen, R¹, —CO₂H, —CO₂R¹, —COR¹, —CSR¹, —CSOR¹, —COSR¹, —CONH₂, —CONHR¹, —CONR¹², —OR¹, —SR¹, —O₂CR¹, —SCOR¹, and —OCSR¹;
where the or each R¹ is independently selected from optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted arylalkyl, optionally substituted heteroarylalkyl, optionally substituted alkylaryl, optionally substituted alkylheteroaryl, and an optionally substituted polymer chain.

The or each R¹ may also be independently selected from optionally substituted C₁-C₂₂ alkyl, optionally substituted C₂-C₂₂ alkenyl, optionally substituted C₂-C₂₂ alkynyl, optionally substituted C₆-C₁₈ aryl, optionally substituted C₃-C₁₈ heteroaryl, optionally substituted C₃-C₁₈ carbocyclyl, optionally substituted C₂-C₁₈ heterocyclyl, optionally substituted C₇-C₂₄ arylalkyl, optionally substituted C₄-C₁₈ heteroarylalkyl, optionally substituted C₇-C₂₄ alkylaryl, optionally substituted C₄-C₁₈ alkylheteroaryl, and an optionally substituted polymer chain.

The or each R¹ may also be selected from optionally substituted C₁-C₁₈ alkyl, optionally substituted C₂-C₁₈ alkenyl, optionally substituted aryl, optionally substituted heteroaryl, optionally substituted carbocyclyl, optionally substituted heterocyclyl, optionally substituted aralkyl, optionally substituted heteroarylalkyl, optionally substituted alkaryl, optionally substituted alkylheteroaryl and a polymer chain.

The or each R¹ may be independently selected from optionally substituted C₁-C₆ alkyl.

Examples of optional substituents for R¹ include those selected from alkyleneoxidyl (epoxy), hydroxy, alkoxy, acyl, acyloxy, formyl, alkylcarbonyl, carboxy, sulfonic acid, alkoxy- or aryloxy-carbonyl, isocyanato, cyano, silyl, halo, amino, including salts and derivatives thereof. Examples polymer chains include those selected from polyalkylene oxide, polyarylene ether and polyalkylene ether.

R¹ may also be selected from optionally substituted C₁-C₁₈ alkyl, optionally substituted C₂-C₁₈ alkenyl, optionally substituted aryl, optionally substituted heteroaryl, optionally substituted carbocyclyl, optionally substituted heterocyclyl, optionally substituted aralkyl, optionally substituted heteroarylalkyl, optionally substituted alkaryl, optionally substituted alkylheteroaryl and polymer chains wherein the substituents are independently selected from the group consisting of alkyleneoxidyl (epoxy), hydroxy, alkoxy, acyl, acyloxy, formyl, alkylcarbonyl, carboxy, sulfonic acid, alkoxy- or aryloxy-carbonyl, isocyanato, cyano, silyl, halo, amino, including salts and derivatives thereof. Preferred polymer chains include, but are not limited to, polyalkylene oxide, polyarylene ether and polyalkylene ether.

Some examples of suitable ethylenically unsaturated monomers include maleic anhydride, N-alkylmaleimide, N-arylmaleimide, dialkyl fumarate and cyclopolymerisable monomers, acrylate and methacrylate esters, acrylic and methacrylic acid, styrene, acrylamide, methacrylamide, and methacrylonitrile, mixtures of these monomers, and mixtures of these monomers with other monomers.

Further examples of useful ethylenically unsaturated monomers include: methyl methacrylate, ethyl methacrylate, propyl methacrylate (all isomers), butyl methacrylate (all isomers), 2-ethylhexyl methacrylate, isobornyl methacrylate, methacrylic acid, benzyl methacrylate, phenyl methacrylate, methacrylonitrile, alpha-methylstyrene, methyl acrylate, ethyl acrylate, propyl acrylate (all isomers), butyl acrylate (all isomers), 2-ethylhexyl acrylate, isobornyl acrylate, acrylic acid, benzyl acrylate, phenyl acrylate, acrylonitrile, styrene, functional methacrylates, acrylates and styrenes selected from glycidyl methacrylate, 2-hydroxyethyl methacrylate, hydroxypropyl methacrylate (all isomers), hydroxybutyl methacrylate (all isomers), N,N-dimethylaminoethyl methacrylate, N,N-diethylaminoethyl methacrylate, triethyleneglycol methacrylate, itaconic anhydride, itaconic acid, glycidyl acrylate, 2-hydroxyethyl acrylate, hydroxypropyl acrylate (all isomers), hydroxybutyl acrylate (all isomers), N,N-dimethylaminoethyl acrylate, N,N-diethylaminoethyl acrylate, triethyleneglycol acrylate, methacrylamide, N-methylacrylamide, N,N-dimethylacrylamide, N-tert-butylmethacrylamide, N-n-butylmethacrylamide, N-methylolmethacrylamide, N-ethylolmethacrylamide, N-tert-butylacrylamide, N-n-butylacrylamide, N-methylolacrylamide, N-ethylolacrylamide, vinyl benzoic acid (all isomers), diethylamino styrene (all isomers), alpha-methylvinyl benzoic acid (all isomers), diethylamino alpha-methylstyrene (all isomers), p-vinylbenzene sulfonic acid, p-vinylbenzene sulfonic sodium salt, trimethoxysilylpropyl methacrylate, triethoxysilylpropyl methacrylate, tributoxysilylpropyl methacrylate, dimethoxymethylsilylpropyl methacrylate, diethoxymethylsilylpropyl methacrylate, dibutoxymethylsilylpropyl methacrylate, diisopropoxymethylsilylpropyl methacrylate, dimethoxysilylpropyl methacrylate, diethoxysilylpropyl methacrylate, dibutoxysilylpropyl methacrylate, diisopropoxysilylpropyl methacrylate, trimethoxysilylpropyl acrylate, triethoxysilylpropyl acrylate, tributoxysilylpropylacrylate, dimethoxymethylsilylpropyl acrylate, diethoxymethylsilylpropyl acrylate, dibutoxymethylsilylpropyl acrylate, diisopropoxymethylsilylpropyl acrylate, dimethoxysilylpropyl acrylate, diethoxysilylpropyl acrylate, dibutoxysilylpropyl acrylate, diisopropoxysilylpropyl acrylate, vinyl acetate, vinyl butyrate, vinyl benzoate, vinyl chloride, vinyl fluoride, vinyl bromide, maleic anhydride, N-phenylmaleimide, N-butylmaleimide, N-vinylpyrrolidone, N-vinylcarbazole, butadiene, ethylene and chloroprene. This list is not exhaustive.

Ethylenically unsaturated monomers used to prepare the non-core shell polymer particles will comprise one or more ionisable ethylenically unsaturated monomers as described herein for preparing the crosslinked RAFT polymer region and possibly the film forming polymer region.

The non-core-shell polymer particles comprise a crosslinked RAFT polymer region. Those skilled in the art will appreciate the acronym “RAFT” stands for Reversible Addition Fragmentation chain Transfer, and that RAFT agents are used in a technique known as RAFT polymerisation.

RAFT polymerisation, as is described in International Patent Publication WO 98/01478, is a radical polymerisation technique that enables polymers to be prepared having a well defined molecular architecture and a narrow molecular weight distribution or low polydispersity.

RAFT polymerisation is believed to proceed under the control of a RAFT agent according to a mechanism which is simplistically illustrated below in Scheme 1.

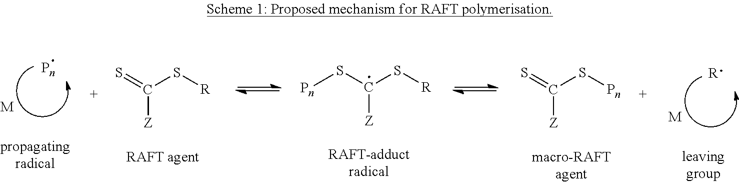

As used herein, a RAFT polymer, a RAFT polymer chain or a crosslinked RAFT polymer region is intended to mean a polymer/polymer chain that has been formed by a RAFT mediated polymerisation mechanism using a RAFT agent. A polymer chain comprising a RAFT agent may be referred to as a macro RAFT agent.

In preparing the non-core-shell polymer particles, ethylenically unsaturated monomers may be polymerised under the control of the RAFT agent. By being polymerised “under the control” of the RAFT agent is meant that polymerisation of the monomers proceeds via a reversible addition-fragmentation chain transfer (RAFT) mechanism to form polymer. Polymers prepared by RAFT polymerisation will typically have a lower polydispersity compared with the polymerisation being conducted in the absence of the RAFT agent.

The polymerisation will usually require initiation from a source of free radicals. The source of initiating radicals can be provided by any suitable method of generating free radicals, such as the thermally induced homolytic scission of suitable compound(s) (thermal initiators such as peroxides, peroxyesters, or azo compounds), the spontaneous generation from monomers (e.g. styrene), redox initiating systems, photochemical initiating systems or high energy radiation such as electron beam, X- or gamma-radiation. The initiating system is chosen such that under the reaction conditions there is no substantial adverse interaction of the initiator or the initiating radicals with the RAFT agent under the conditions of the reaction. The initiator ideally should also have the requisite solubility in the reaction medium.

Thermal initiators are chosen to have an appropriate half life at the temperature of polymerisation. These initiators can include one or more of the following compounds:
2,2′-azobis(isobutyronitrile), 2,2′-azobis(2-cyanobutane), dimethyl 2,2′-azobis(isobutyrate), 4,4′-azobis(4-cyanovaleric acid), 1,1′-azobis(cyclohexanecarbonitrile), 2-(t-butylazo)-2-cyanopropane, 2,2′-azobis{2-methyl-N-[1,1-bis(hydroxymethyl)-2-hydroxyethyl]propionamide}, 2,2′-azobis[2-methyl-N-(2-hydroxyethyl)propionamide], 2,2′-azobis(N,N′-dimethyleneisobutyramidine) dihydrochloride, 2,2′-azobis(2-amidinopropane) dihydrochloride, 2,2′-azobis(N,N′-dimethyleneisobutyramidine), 2,2′-azobis{2-methyl-N-[1,1-bis(hydroxymethyl)-2-hydroxyethyl]propionamide}, 2,2′-azobis{2-methyl-N-[1,1-bis(hydroxymethyl)-2-ethyl]propionamide}, 2,2′-azobis[2-methyl-N-(2-hydroxyethyl)propionamide], 2,2′-azobis(isobutyramide) dihydrate, 2,2′-azobis(2,2,4-trimethylpentane), 2,2′-azobis(2-methylpropane), t-butyl peroxyacetate, t-butyl peroxybenzoate, t-butyl peroxyneodecanoate, t-butylperoxy isobutyrate, t-amyl peroxypivalate, t-butyl peroxypivalate, diisopropyl peroxydicarbonate, dicyclohexyl peroxydicarbonate, dicumyl peroxide, dibenzoyl peroxide, dilauroyl peroxide, potassium peroxydisulfate, ammonium peroxydisulfate, di-t-butyl hyponitrite, dicumyl hyponitrite. This list is not exhaustive.

Photochemical initiator systems are chosen to have the requisite solubility in the reaction medium and have an appropriate quantum yield for radical production under the conditions of the polymerisation. Examples include benzoin derivatives, benzophenone, acyl phosphine oxides, and photo-redox systems.

Redox initiator systems are chosen to have the requisite solubility in the reaction medium and have an appropriate rate of radical production under the conditions of the polymerisation; these initiating systems can include, but are not limited to, combinations of the following oxidants and reductants:
oxidants: potassium, peroxydisulfate, hydrogen peroxide, t-butyl hydroperoxide.
reductants: iron (II), titanium (III), potassium thiosulfite, potassium bisulfite.

Other suitable initiating systems are described in recent texts. See, for example, Moad and Solomon “the Chemistry of Free Radical Polymerisation”, Pergamon, London, 1995, pp 53-95.

Preferred initiating systems for conventional and mini-emulsion processes are those which are appreciably water soluble. Suitable water soluble initiators include, but are not limited to, 4,4-azobis(cyanovaleric acid), 2,2′-azobis{2-methyl-N-[1,1-bis(hydroxymethyl)-2-hydroxyethyl]propionamide}, 2,2′-azobis[2-methyl-N-(2-hydroxyethyl)propionamide], 2,2′-azobis(N,N′-dimethyleneisobutyramidine), 2,2′-azobis(N,N′-dimethyleneisobutyramidine) dihydrochloride, 2,2′-azobis(2-amidinopropane) dihydrochloride, 2,2′-azobis{2-methyl-N-[1,1-bis(hydroxymethyl)-2-ethyl]propionamide}, 2,2′-azobis[2-methyl-N-(2-hydroxyethyl)propionamide], 2,2′-azobis(isobutyramide) dihydrate, and derivatives thereof.

Preferred initiating systems for suspension polymerization are those which are appreciably soluble in the monomer to be polymerized. Suitable monomer soluble initiators may vary depending on the polarity of the monomer, but typically would include oil soluble initiators such as azo compounds exemplified by the well-known material 2,2′-azobisisobutyronitrile. The other class of readily available compounds are the acyl peroxide class such as acetyl and benzoyl peroxide as well as alkyl peroxides such as cumyl and t-butyl peroxides. Hydroperoxides such as t-butyl and cumyl hydroperoxides are also widely used. A convenient method of initiation applicable to suspension processes is redox initiation where radical production occurs at more moderate temperatures. This can aid in maintaining stability of the polymer particles from heat induced aggregation processes.

The crosslinked RAFT polymer region may be formed by crosslinking a seed polymer particle to form a crosslinked seed polymer particle that is then used to form a non-core-shell polymer particle. By “crosslinking” is meant a reaction involving sites or groups on existing polymer chains or an interaction between existing polymer chains that results in the formation of at least a small region in the polymer chains from which at least four chains emanate.

The crosslinked seed polymer particles may be formed by any suitable means. Crosslinking may take place during formation of the seed polymer particles (i.e. as part of the polymerisation process), the seed particles may be formed and then subsequently crosslinked, or a combination of such techniques may be employed.

Those skilled in the art will appreciate that crosslinking may be achieved in numerous ways. For example, crosslinking may be achieved using multi-ethylenically unsaturated monomers. In that case, crosslinking is typically derived through a free radical reaction mechanism.

Alternatively, crosslinking may be achieved using ethylenically unsaturated monomers which also contain a reactive functional group that is not susceptible to taking part in free radical reactions (i.e. “functionalised” unsaturated monomers). In that case, such monomers may be incorporated into the polymer backbone through polymerisation of the unsaturated group, and the resulting pendant functional group provides means through which crosslinking may occur. By utilising monomers that provide complementary pairs of reactive functional groups (i.e. groups that will react with each other), the pairs of reactive functional groups can react through non-radical reaction mechanisms to provide crosslinks.

A variation on using complementary pairs of reactive functional groups is where the monomers are provided with non-complementary reactive functional groups. In that case, the functional groups will not react with each other but instead provide sites which can subsequently be reacted with a crosslinking agent to form the crosslinks. It will be appreciated that such crosslinking agents will be used in an amount to react with substantially all of the non-complementary reactive functional groups. Formation of the crosslinks under these circumstances will generally occur after polymerisation of the monomers. For example, seed particles may be formed where the polymer chains are provided with non-complementary groups, a crosslinking agent, capable of transfer through the aqueous phase, may then be added to the dispersion to diffuse into the particles and crosslink the polymer chains. In order to facilitate the diffusion of the cross-linking agent into the particles it may prove useful to plasticise the particles with a small amount of monomer prior to adding the cross-linking agent.

A combination of these crosslinking techniques may be used.

The terms “multi-ethylenically unsaturated monomers” and “functionalised unsaturated monomers” mentioned herein can conveniently and collectively also be referred to herein as “crosslinking ethylenically unsaturated monomers” or “crosslinking monomers”. By the general term “crosslinking ethylenically unsaturated monomers” or “crosslinking monomers” it is meant an ethylenically unsaturated monomer through which a crosslink is or will be derived.

It will be appreciated that not all unsaturated monomers that contain a functional group will be used for the purpose of functioning as a crosslinking monomer. For example, acrylic acid should not be considered as a crosslinking monomer unless it is used to provide a site through which a crosslink is to be derived.

Examples of multi-ethylenically unsaturated monomers that may be used include ethylene glycol di(meth)acrylate, triethylene glycol di(meth)acrylate, tetraethylene glycol di(meth)acrylate, 1,3-butylene glycol di(meth)acrylate, trimethylolpropane tri(meth)acrylate, 1,4-butanediol di(meth)acrylate, neopentyl glycol di(meth)acrylate, 1,6-hexanediol di(meth)acrylate, pentaerythritol di(meth)acrylate, pentaerythritol tri(meth)acrylate, pentaerythritol tetra(meth)acrylate, glycerol di(meth)acrylate, glycerol allyloxy di(meth)acrylate, 1,1,1-tris(hydroxymethyl)ethane di(meth)acrylate, 1,1,1-tris(hydroxymethyl)ethane tri(meth)acrylate, 1,1,1-tris(hydroxymethyl)propane di(meth)acrylate, 1,1,1-tris(hydroxymethyl)propane tri(meth)acrylate, triallyl cyanurate, triallyl isocyanurate, triallyl trimellitate, diallyl phthalate, diallyl terephthalte, divinyl benzene, methylol (meth)acrylamide, triallylamine, oleyl maleate, glyceryl propoxy triacrylate, allyl methacrylate, methacrylic anhydride and methylenebis (meth) acrylamide.

Examples of ethylenically unsaturated monomers which contain a reactive functional group that is not susceptible to taking part in free radical reactions include acetoacetoxyethyl methacrylate, glycidyl methacrylate, N-methylolacrylamide, (isobutoxymethyl)acrylamide, hydroxyethyl acrylate, t-butyl-carbodiimidoethyl methacrylate, acrylic acid, γ-methacryloxypropyltriisopropoxysilane, 2-isocyanoethyl methacrylate and diacetone acrylamide.

Examples of pairs of monomers mentioned directly above that provide complementary reactive functional groups include N-methylolacrylamide and itself, (isobutoxymethyl)acrylamide and itself, γ-methacryloxypropyltriisopropoxysilane and itself, 2-isocyanoethyl methacrylate and hydroxyethyl acrylate, and t-butyl-carbodiimidoethyl methacrylate and acrylic acid.

Examples of crosslinking agents that can react with the reactive functional groups of one or more of the functionalised unsaturated monomers mentioned above include hexamethylene diamine, melamine, trimethylolpropane tris(2-methyl-1-aziridine propionate) and adipic bishydrazide. Examples of pairs of crosslinking agents and functionalised unsaturated monomers that provide complementary reactive groups include hexamethylene diamine and acetoacetoxyethyl methacrylate, hexamethylene diamine and glycidyl methacrylate, melamine and hydroxyethyl acrylate, trimethylolpropane tris(2-methyl-1-aziridine propionate) and acrylic acid, adipic bishydrazide and diacetone acrylamide.

Depending upon the manner in which crosslinking is achieved, it will be appreciated the one or more ethylenically unsaturated monomers that are polymerised to form seed polymer particles may comprise a mixture of non-crosslinking and crosslinking monomers. Alternatively, seed polymer particles may be formed from non-crosslinking monomers and subsequently swollen with crosslinking monomers that are in turn reacted to form the crosslinked seed polymer particles. In forming the crosslinked seed polymer particles, the crosslinking monomers will generally also be polymerised under the control of the RAFT agent. Using RAFT controlled radical polymerisation to form the seed has the advantage of allowing the seed to be crosslinked by adding a free radical crosslinker as the last operation in its formation and obviates the need to have the multi ethylenically unsaturated monomer as part of the monomer feed. It also allows very small crosslinked seed particles to be prepared without the use of surfactant.

When the seed polymer particles are prepared using batch polymerisation techniques such as miniemulsion polymerisation, the one or more ethylenically unsaturated monomers that are polymerised to form the seed polymer particles will generally comprise a mixture of non-crosslinking and crosslinking monomers.

The non-core-shell polymer particles in accordance with the invention may be prepared such that the crosslinked RAFT polymer region comprises one or more voids (i.e. hollow sections) and/or particulate material. Examples of such particulate material includes the preformed solid particulate materials herein described.

In one embodiment, the crosslinked RAFT polymer region comprises one or more voids.

In another embodiment, the crosslinked RAFT polymer region comprises particulate material.

Where the crosslinked RAFT polymer region comprises a void and/or particulate material, the resulting non-core-shell polymer particles in accordance with the invention can not only be used to form polymer film on a pre-formed solid substrate surface, but that polymer film can add functionality to the coated pre-formed solid substrate. For example, the non-core-shell polymer particles can impart to the polymer film coated pre-formed solid functionality such as opacity, colour, fire resistance, bioactivity etc.

As the method of the invention is performed in a liquid, it will be appreciated voids in the crosslinked RAFT polymer region may be filled with that liquid. When the so formed solid substrate having polymer film adsorbed on a surface thereof is removed from the liquid, liquid within the voids will typically drain or evaporate to leave, for example air filled voids. Accordingly, in the context of the present invention, a void may also be a liquid filled void.

The method of performing the invention is advantageously simple and merely requires as a main step contacting in a liquid the pre-formed solid substrate surface with the non-core-shell polymer particles dispersed in the liquid. The non-core-shell polymer particles adsorb to the surface of the pre-formed solid substrate and proceed to form a polymer film thereon. Further detail on that process is presented in the Example section below.

The method according to the invention may also further comprise polymerising monomer so as to increase the thickness of the so formed polymer film. For example, monomer may be introduced into the liquid and polymerisation of the monomer increases the thickness of the polymer film. Without wishing to me limited by theory, it is believed the introduced monomer is absorbed within the so formed polymer film and polymerisation of that monomer increases the polymer content of the film and consequently the thickness of the polymer film.

In one embodiment, monomer is introduced into the liquid and polymerised so as to increase the thickness of the polymer film.

Suitable monomers for use in such an embodiment include those herein described.

The present invention further provides solid substrate having polymer film adsorbed on a surface thereof, said polymer film comprising a plurality of polymer regions that (i) are different in molecular composition to the polymer film, (ii) are covalently coupled to the polymer film, and (iii) comprise (a) crosslinked RAFT polymer, and (b) particle aggregation prevention means selected from one or more of charged and steric stabilising functionality, wherein said polymer film comprises 0-3 wt. % of charged polymerised monomer residues relative to the total amount of polymerised monomer residues present in the film.

The present invention also provides solid particulate material encapsulated in a polymer film, said polymer film comprising a plurality of polymer regions that (i) are different in molecular composition to the polymer film, (ii) are covalently coupled to the polymer film, and (iii) comprise (a) crosslinked RAFT polymer, and (b) particle aggregation prevention means selected from one or more of charged and steric stabilising functionality, wherein said polymer film comprises 0-3 wt. % of charged polymerised monomer residues relative to the total amount of polymerised monomer residues present in the film.

It will be appreciated the polymer film associated with (adsorbed to) the solid substrate/solid particulate material is in effect derived from the film forming polymer regions of the non-core-shell polymer particles that have undergone coalescence as described herein.

In preparing the non-core-shell polymer particles used according to the invention one tends to seek to achieve a film forming polymer region that is only just colloidally stable relative to the preformed solid substrate surface on which the polymer film is to me formed. The intention is to not have the film forming polymer region adhere strongly to the surface of the preformed solid substrate but rather it is believed the film forming polymer region of the non-core-shell polymer particles should associate with the surface of the pre-formed solid substrate through primarily hydrophobic attractive forces.

If charge is present on the surface of the film forming polymer region that can be achieved by one or more of i) incorporating some ionisable monomer into the copolymer making up that region and if required appropriately controlling the pH; ii) including an appropriate amount of charged initiator into the formulation of the region; and iii) incorporating an amount of surfactant into the formulation at an appropriate point during the overall process.

Where pre-formed solid substrate is in the form of preformed solid particulate material, step (iii) above may involve a process wherein a dispersion of preformed solid particles is stirred together with a dispersion of non-core-shell polymer particles. In some instances the dispersion of preformed solid particles can be readily maintained as a dispersion as a consequence of the inherent charge on the surface of the particles themselves. A variety of milling methods may be used to achieve such a dispersion and the mill chosen will generally be one of those common to the relevant industry sector. Once the required level of dispersion has been achieved, the dispersion of non-core-shell polymer particles can be blended with the dispersion of preformed solid substrate particles in an amount that reflects the surface area of the preformed substrate particles and the thickness of the desired film that is to form. Film thickness can be controlled by the changing the size of the non-core-shell particles or by using multi layers of smaller particles.

Where the preformed solid substrate particles require more than their own inherent surface charge to enable them to remain stable in dispersion it may be useful to use a surfactant to aid in their stabilisation. Virtually any surfactant that serves this purpose will suffice. If the surfactant used is a highly mobile small molecule surfactant such as sodium dodecyl sulphate then that surfactant can move away as the non-core-shell polymer particles approach the surface and the non-core-shell polymer particles can readily form the polymer film directly on the preformed solid substrate surface. Alternatively, if a larger less mobile polymeric surfactant, such as an anionic polyelectrolyte like copolymerised maleic acid, is used the surfactant could remain on the preformed solid substrate surface present between the preformed solid substrate and the so formed polymer film.

As used herein, the term “alkyl”, used either alone or in compound words denotes straight chain, branched or cyclic alkyl, preferably C₁₋₂₀ alkyl, e.g. C₁₋₁₀ or C₁₋₆. Examples of straight chain and branched alkyl include methyl, ethyl, n-propyl, isopropyl, n-butyl, sec-butyl, t-butyl, n-pentyl, 1,2-dimethylpropyl, 1,1-dimethyl-propyl, hexyl, 4-methylpentyl, 1-methylpentyl, 2-methylpentyl, 3-methylpentyl, 1,1-dimethylbutyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl, heptyl, 5-methylhexyl, 1-methylhexyl, 2,2-dimethylpentyl, 3,3-dimethylpentyl, 4,4-dimethylpentyl, 1,2-dimethylpentyl, 1,3-dimethylpentyl, 1,4-dimethyl-pentyl, 1,2,3-trimethylbutyl, 1,1,2-trimethylbutyl, 1,1,3-trimethylbutyl, octyl, 6-methylheptyl, 1-methylheptyl, 1,1,3,3-tetramethylbutyl, nonyl, 1-, 2-, 3-, 4-, 5-, 6- or 7-methyloctyl, 1-, 2-, 3-, 4- or 5-ethylheptyl, 1-, 2- or 3-propylhexyl, decyl, 1-, 2-, 3-, 4-, 5-, 6-, 7- and 8-methylnonyl, 1-, 2-, 3-, 4-, 5- or 6-ethyloctyl, 1-, 2-, 3- or 4-propylheptyl, undecyl, 1-, 2-, 3-, 4-, 5-, 6-, 7-, 8- or 9-methyldecyl, 1-, 2-, 3-, 4-, 5-, 6- or 7-ethylnonyl, 1-, 2-, 3-, 4- or 5-propyloctyl, 1-, 2- or 3-butylheptyl, 1-pentylhexyl, dodecyl, 1-, 2-, 3-, 4-, 5-, 6-, 7-, 8-, 9- or 10-methylundecyl, 1-, 2-, 3-, 4-, 5-, 6-, 7- or 8-ethyldecyl, 1-, 2-, 3-, 4-, 5- or 6-propylnonyl, 1-, 2-, 3- or 4-butyloctyl, 1-2-pentylheptyl and the like. Examples of cyclic alkyl include mono- or polycyclic alkyl groups such as cyclopropyl, cyclobutyl, cyclopentyl, cyclohexyl, cycloheptyl, cyclooctyl, cyclononyl, cyclodecyl and the like. Where an alkyl group is referred to generally as “propyl”, butyl” etc, it will be understood that this can refer to any of straight, branched and cyclic isomers where appropriate. An alkyl group may be optionally substituted by one or more optional substituents as herein defined.

The term “alkenyl” as used herein denotes groups formed from straight chain, branched or cyclic hydrocarbon residues containing at least one carbon to carbon double bond including ethylenically mono-, di- or polyunsaturated alkyl or cycloalkyl groups as previously defined, preferably C₂₋₂₀ alkenyl (e.g. C₂₋₁₀ or C₂₋₆). Examples of alkenyl include vinyl, allyl, 1-methylvinyl, butenyl, iso-butenyl, 3-methyl-2-butenyl, 1-pentenyl, cyclopentenyl, 1-methyl-cyclopentenyl, 1-hexenyl, 3-hexenyl, cyclohexenyl, 1-heptenyl, 3-heptenyl, 1-octenyl, cyclooctenyl, 1-nonenyl, 2-nonenyl, 3-nonenyl, 1-decenyl, 3-decenyl, 1,3-butadienyl, 1,4-pentadienyl, 1,3-cyclopentadienyl, 1,3-hexadienyl, 1,4-hexadienyl, 1,3-cyclohexadienyl, 1,4-cyclohexadienyl, 1,3-cycloheptadienyl, 1,3,5-cycloheptatrienyl and 1,3,5,7-cyclooctatetraenyl. An alkenyl group may be optionally substituted by one or more optional substituents as herein defined.

As used herein the term “alkynyl” denotes groups formed from straight chain, branched or cyclic hydrocarbon residues containing at least one carbon-carbon triple bond including ethylenically mono-, di- or polyunsaturated alkyl or cycloalkyl groups as previously defined. Unless the number of carbon atoms is specified the term preferably refers to C₂₋₂₀ alkynyl (e.g. C₂₋₁₀ or C₂₋₆). Examples include ethynyl, 1-propynyl, 2-propynyl, and butynyl isomers, and pentynyl isomers. An alkynyl group may be optionally substituted by one or more optional substituents as herein defined.

The term “halogen” (“halo”) denotes fluorine, chlorine, bromine or iodine (fluoro, chloro, bromo or iodo).

The term “aryl” (or “carboaryl”) denotes any of single, polynuclear, conjugated and fused residues of aromatic hydrocarbon ring systems, preferably C₆₋₂₄ (e.g. C₆₋₁₈ or C₆₋₁₂). Examples of aryl include phenyl, biphenyl, terphenyl, quaterphenyl, naphthyl, tetrahydronaphthyl, anthracenyl, dihydroanthracenyl, benzanthracenyl, dibenzanthracenyl, phenanthrenyl, fluorenyl, pyrenyl, idenyl, azulenyl, chrysenyl. Preferred aryl include phenyl and naphthyl. An aryl group may or may not be optionally substituted by one or more optional substituents as herein defined. The term “arylene” is intended to denote the divalent form of aryl.

The term “carbocyclyl” includes any of non-aromatic monocyclic, polycyclic, fused or conjugated hydrocarbon residues, preferably C₃₋₂₀ (e.g. C₃₋₁₀ or C₃₋₈). The rings may be saturated, e.g. cycloalkyl, or may possess one or more double bonds (cycloalkenyl) and/or one or more triple bonds (cycloalkynyl). Particularly preferred carbocyclyl moieties are 5-6-membered or 9-10 membered ring systems. Suitable examples include cyclopropyl, cyclobutyl, cyclopentyl, cyclohexyl, cycloheptyl, cyclooctyl, cyclononyl, cyclodecyl, cyclopentenyl, cyclohexenyl, cyclooctenyl, cyclopentadienyl, cyclohexadienyl, cyclooctatetraenyl, indanyl, decalinyl and indenyl. A carbocyclyl group may be optionally substituted by one or more optional substituents as herein defined. The term “carbocyclylene” is intended to denote the divalent form of carbocyclyl.

The term “heteroatom” or “hetero” as used herein in its broadest sense refers to any atom other than a carbon atom which may be a member of a cyclic organic group. Particular examples of heteroatoms include nitrogen, oxygen, sulfur, phosphorous, boron, silicon, selenium and tellurium, more particularly nitrogen, oxygen and sulfur.

The term “heterocyclyl” when used alone or in compound words includes any of monocyclic, polycyclic, fused or conjugated hydrocarbon residues, preferably C₃₋₂₀ (e.g. C₃₋₁₀ or C₃₋₈) wherein one or more carbon atoms are replaced by a heteroatom so as to provide a non-aromatic residue. Suitable heteroatoms include O, N, S, P and Se, particularly O, N and S. Where two or more carbon atoms are replaced, this may be by two or more of the same heteroatom or by different heteroatoms. The heterocyclyl group may be saturated or partially unsaturated, i.e. possess one or more double bonds. Particularly preferred heterocyclyl are 5-6 and 9-10 membered heterocyclyl. Suitable examples of heterocyclyl groups may include azridinyl, oxiranyl, thiiranyl, azetidinyl, oxetanyl, thietanyl, 2H-pyrrolyl, pyrrolidinyl, pyrrolinyl, piperidyl, piperazinyl, morpholinyl, indolinyl, imidazolidinyl, imidazolinyl, pyrazolidinyl, thiomorpholinyl, dioxanyl, tetrahydrofuranyl, tetrahydropyranyl, tetrahydropyrrolyl, tetrahydrothiophenyl, pyrazolinyl, dioxalanyl, thiazolidinyl, isoxazolidinyl, dihydropyranyl, oxazinyl, thiazinyl, thiomorpholinyl, oxathianyl, dithianyl, trioxanyl, thiadiazinyl, dithiazinyl, trithianyl, azepinyl, oxepinyl, thiepinyl, indenyl, indanyl, 3H-indolyl, isoindolinyl, 4H-quinolazinyl, chromenyl, chromanyl, isochromanyl, pyranyl and dihydropyranyl. A heterocyclyl group may be optionally substituted by one or more optional substituents as herein defined. The term “heterocyclylene” is intended to denote the divalent form of heterocyclyl.

The term “heteroaryl” includes any of monocyclic, polycyclic, fused or conjugated hydrocarbon residues, wherein one or more carbon atoms are replaced by a heteroatom so as to provide an aromatic residue. Preferred heteroaryl have 3-20 ring atoms, e.g. 3-10. Particularly preferred heteroaryl are 5-6 and 9-10 membered bicyclic ring systems. Suitable heteroatoms include, O, N, S, P and Se, particularly O, N and S. Where two or more carbon atoms are replaced, this may be by two or more of the same heteroatom or by different heteroatoms. Suitable examples of heteroaryl groups may include pyridyl, pyrrolyl, thienyl, imidazolyl, furanyl, benzothienyl, isobenzothienyl, benzofuranyl, isobenzofuranyl, indolyl, isoindolyl, pyrazolyl, pyrazinyl, pyrimidinyl, pyridazinyl, indolizinyl, quinolyl, isoquinolyl, phthalazinyl, 1,5-naphthyridinyl, quinozalinyl, quinazolinyl, quinolinyl, oxazolyl, thiazolyl, isothiazolyl, isoxazolyl, triazolyl, oxadialzolyl, oxatriazolyl, triazinyl, and furazanyl. A heteroaryl group may be optionally substituted by one or more optional substituents as herein defined. The term “heteroarylene” is intended to denote the divalent form of heteroaryl.

The term “acyl” either alone or in compound words denotes a group containing the moiety C═O (and not being a carboxylic acid, ester or amide) Preferred acyl includes C(O)—R^{e}, wherein R^{e} is hydrogen or an alkyl, alkenyl, alkynyl, aryl, heteroaryl, carbocyclyl, or heterocyclyl residue. Examples of acyl include formyl, straight chain or branched alkanoyl (e.g. C₁₋₂₀) such as acetyl, propanoyl, butanoyl, 2-methylpropanoyl, pentanoyl, 2,2-dimethylpropanoyl, hexanoyl, heptanoyl, octanoyl, nonanoyl, decanoyl, undecanoyl, dodecanoyl, tridecanoyl, tetradecanoyl, pentadecanoyl, hexadecanoyl, heptadecanoyl, octadecanoyl, nonadecanoyl and icosanoyl; cycloalkylcarbonyl such as cyclopropylcarbonyl cyclobutylcarbonyl, cyclopentylcarbonyl and cyclohexylcarbonyl; aroyl such as benzoyl, toluoyl and naphthoyl; aralkanoyl such as phenylalkanoyl (e.g. phenylacetyl, phenylpropanoyl, phenylbutanoyl, phenylisobutylyl, phenylpentanoyl and phenylhexanoyl) and naphthylalkanoyl (e.g. naphthylacetyl, naphthylpropanoyl and naphthylbutanoyl]; aralkenoyl such as phenylalkenoyl (e.g. phenylpropenoyl, phenylbutenoyl, phenylmethacryloyl, phenylpentenoyl and phenylhexenoyl and naphthylalkenoyl (e.g. naphthylpropenoyl, naphthylbutenoyl and naphthylpentenoyl); aryloxyalkanoyl such as phenoxyacetyl and phenoxypropionyl; arylthiocarbamoyl such as phenylthiocarbamoyl; arylglyoxyloyl such as phenylglyoxyloyl and naphthylglyoxyloyl; arylsulfonyl such as phenylsulfonyl and napthylsulfonyl; heterocycliccarbonyl; heterocyclicalkanoyl such as thienylacetyl, thienylpropanoyl, thienylbutanoyl, thienylpentanoyl, thienylhexanoyl, thiazolylacetyl, thiadiazolylacetyl and tetrazolylacetyl; heterocyclicalkenoyl such as heterocyclicpropenoyl, heterocyclicbutenoyl, heterocyclicpentenoyl and heterocyclichexenoyl; and heterocyclicglyoxyloyl such as thiazolyglyoxyloyl and thienylglyoxyloyl. The R^{e} residue may be optionally substituted as described herein.

The term “sulfoxide”, either alone or in a compound word, refers to a group —S(O)R^{f} wherein R^{f} is selected from hydrogen, alkyl, alkenyl, alkynyl, aryl, heteroaryl, heterocyclyl, carbocyclyl, and aralkyl. Examples of preferred R^{f} include C₁₋₂₀alkyl, phenyl and benzyl.

The term “sulfonyl”, either alone or in a compound word, refers to a group S(O)₂—R^{f}, wherein R^{f} is selected from hydrogen, alkyl, alkenyl, alkynyl, aryl, heteroaryl, heterocyclyl, carbocyclyl and aralkyl. Examples of preferred R^{f} include C₁₋₂₀alkyl, phenyl and benzyl.

The term “sulfonamide”, either alone or in a compound word, refers to a group S(O)NR^{f}R^{f} wherein each R^{f} is independently selected from hydrogen, alkyl, alkenyl, alkynyl, aryl, heteroaryl, heterocyclyl, carbocyclyl, and aralkyl. Examples of preferred R^{f} include C₁₋₂₀alkyl, phenyl and benzyl. In one embodiment at least one R^{f} is hydrogen. In another embodiment, both R^{f} are hydrogen.

The term, “amino” is used here in its broadest sense as understood in the art and includes groups of the formula NR^{a}R^{b} wherein R^{a} and R^{b} may be any independently selected from hydrogen, alkyl, alkenyl, alkynyl, aryl, carbocyclyl, heteroaryl, heterocyclyl, arylalkyl, and acyl. R^{a} and R^{b}, together with the nitrogen to which they are attached, may also form a monocyclic, or polycyclic ring system e.g. a 3-10 membered ring, particularly, 5-6 and 9-10 membered systems. Examples of “amino” include NH₂, NHalkyl (e.g. C₁₋₂₀alkyl), NHaryl (e.g. NHphenyl), NHaralkyl (e.g. NHbenzyl), NHacyl (e.g. NHC(O)C₁₋₂₀alkyl, NHC(O)phenyl), Nalkylalkyl (wherein each alkyl, for example C₁₋₂₀, may be the same or different) and 5 or 6 membered rings, optionally containing one or more same or different heteroatoms (e.g. O, N and S).

The term “amido” is used here in its broadest sense as understood in the art and includes groups having the formula C(O)NR^{a}R^{b}, wherein R^{a} and R^{b} are as defined as above. Examples of amido include C(O)NH₂, C(O)NHalkyl (e.g. C₁₋₂₀alkyl), C(O)NHaryl (e.g. C(O)NHphenyl), C(O)NHaralkyl (e.g. C(O)NHbenzyl), C(O)NHacyl (e.g. C(O)NHC(O)C₁₋₂₀alkyl, C(O)NHC(O)phenyl), C(O)Nalkylalkyl (wherein each alkyl, for example C₁₋₂₀, may be the same or different) and 5 or 6 membered rings, optionally containing one or more same or different heteroatoms (e.g. O, N and S).

The term “carboxy ester” is used here in its broadest sense as understood in the art and includes groups having the formula CO₂R⁹, wherein R⁹ may be selected from groups including alkyl, alkenyl, alkynyl, aryl, carbocyclyl, heteroaryl, heterocyclyl, aralkyl, and acyl. Examples of carboxy ester include CO₂C₁₋₂₀alkyl, CO₂ aryl (e.g. CO₂phenyl), CO₂aralkyl (e.g. CO₂ benzyl).

As used herein, the term “aryloxy” refers to an “aryl” group attached through an oxygen bridge. Examples of aryloxy substituents include phenoxy, biphenyloxy, naphthyloxy and the like.

As used herein, the term “acyloxy” refers to an “acyl” group wherein the “acyl” group is in turn attached through an oxygen atom. Examples of “acyloxy” include hexylcarbonyloxy (heptanoyloxy), cyclopentylcarbonyloxy, benzoyloxy, 4-chlorobenzoyloxy, decylcarbonyloxy (undecanoyloxy), propylcarbonyloxy (butanoyloxy), octylcarbonyloxy (nonanoyloxy), biphenylcarbonyloxy (eg 4-phenylbenzoyloxy), naphthylcarbonyloxy (eg 1-naphthoyloxy) and the like.

As used herein, the term “alkyloxycarbonyl” refers to a “alkyloxy” group attached through a carbonyl group. Examples of “alkyloxycarbonyl” groups include butylformate, sec-butylformate, hexylformate, octylformate, decylformate, cyclopentylformate and the like.

As used herein, the term “arylalkyl” refers to groups formed from straight or branched chain alkanes substituted with an aromatic ring. Examples of arylalkyl include phenylmethyl (benzyl), phenylethyl and phenylpropyl.

As used herein, the term “alkylaryl” refers to groups formed from aryl groups substituted with a straight chain or branched alkane. Examples of alkylaryl include methylphenyl and isopropylphenyl.

In this specification “optionally substituted” is taken to mean that a group may or may not be substituted or fused (so as to form a condensed polycyclic group) with one, two, three or more of organic and inorganic groups, including those selected from: alkyl, alkenyl, alkynyl, carbocyclyl, aryl, heterocyclyl, heteroaryl, acyl, aralkyl, alkaryl, alkheterocyclyl, alkheteroaryl, alkcarbocyclyl, halo, haloalkyl, haloalkenyl, haloalkynyl, haloaryl, halocarbocyclyl, haloheterocyclyl, haloheteroaryl, haloacyl, haloaryalkyl, hydroxy, hydroxyalkyl, hydroxyalkenyl, hydroxyalkynyl, hydroxycarbocyclyl, hydroxyaryl, hydroxyheterocyclyl, hydroxyheteroaryl, hydroxyacyl, hydroxyaralkyl, alkoxyalkyl, alkoxyalkenyl, alkoxyalkynyl, alkoxycarbocyclyl, alkoxyaryl, alkoxyheterocyclyl, alkoxyheteroaryl, alkoxyacyl, alkoxyaralkyl, alkoxy, alkenyloxy, alkynyloxy, aryloxy, carbocyclyloxy, aralkyloxy, heteroaryloxy, heterocyclyloxy, acyloxy, haloalkoxy, haloalkenyloxy, haloalkynyloxy, haloaryloxy, halocarbocyclyloxy, haloaralkyloxy, haloheteroaryloxy, haloheterocyclyloxy, haloacyloxy, nitro, nitroalkyl, nitroalkenyl, nitroalkynyl, nitroaryl, nitroheterocyclyl, nitroheteroayl, nitrocarbocyclyl, nitroacyl, nitroaralkyl, amino (NH₂), alkylamino, dialkylamino, alkenylamino, alkynylamino, arylamino, diarylamino, aralkylamino, diaralkylamino, acylamino, diacylamino, heterocyclamino, heteroarylamino, carboxy, carboxyester, amido, alkylsulphonyloxy, arylsulphenyloxy, alkylsulphenyl, arylsulphenyl, thio, alkylthio, alkenylthio, alkynylthio, arylthio, aralkylthio, carbocyclylthio, heterocyclylthio, heteroarylthio, acylthio, sulfoxide, sulfonyl, sulfonamide, aminoalkyl, aminoalkenyl, aminoalkynyl, aminocarbocyclyl, aminoaryl, aminoheterocyclyl, aminoheteroaryl, aminoacyl, aminoaralkyl, thioalkyl, thioalkenyl, thioalkynyl, thiocarbocyclyl, thioaryl, thioheterocyclyl, thioheteroaryl, thioacyl, thioaralkyl, carboxyalkyl, carboxyalkenyl, carboxyalkynyl, carboxycarbocyclyl, carboxyaryl, carboxyheterocyclyl, carboxyheteroaryl, carboxyacyl, carboxyaralkyl, carboxyesteralkyl, carboxyesteralkenyl, carboxyesteralkynyl, carboxyestercarbocyclyl, carboxyesteraryl, carboxyesterheterocyclyl, carboxyesterheteroaryl, carboxyesteracyl, carboxyesteraralkyl, amidoalkyl, amidoalkenyl, amidoalkynyl, amidocarbocyclyl, amidoaryl, amidoheterocyclyl, amidoheteroaryl, amidoacyl, amidoaralkyl, formylalkyl, formylalkenyl, formylalkynyl, formylcarbocyclyl, formylaryl, formylheterocyclyl, formylheteroaryl, formylacyl, formylaralkyl, acylalkyl, acylalkenyl, acylalkynyl, acylcarbocyclyl, acylaryl, acylheterocyclyl, acylheteroaryl, acylacyl, acylaralkyl, sulfoxidealkyl, sulfoxidealkenyl, sulfoxidealkynyl, sulfoxidecarbocyclyl, sulfoxidearyl, sulfoxideheterocyclyl, sulfoxideheteroaryl, sulfoxideacyl, sulfoxidearalkyl, sulfonylalkyl, sulfonylalkenyl, sulfonylalkynyl, sulfonylcarbocyclyl, sulfonylaryl, sulfonylheterocyclyl, sulfonylheteroaryl, sulfonylacyl, sulfonylaralkyl, sulfonamidoalkyl, sulfonamidoalkenyl, sulfonamidoalkynyl, sulfonamidocarbocyclyl, sulfonamidoaryl, sulfonamidoheterocyclyl, sulfonamidoheteroaryl, sulfonamidoacyl, sulfonamidoaralkyl, nitroalkyl, nitroalkenyl, nitroalkynyl, nitrocarbocyclyl, nitroaryl, nitroheterocyclyl, nitroheteroaryl, nitroacyl, nitroaralkyl, cyano, sulfate, phosphate, triarylmethyl, triarylamino, oxadiazole, and carbazole groups. Optional substitution may also be taken to refer to where a —CH₂— group in a chain or ring is replaced by a group selected from —O—, —S—, —NR^{a}—, —C(O)— (i.e. carbonyl), —C(O)O— (i.e. ester), and —C(O)NR^{a}— (i.e. amide), where R^{a} is as defined herein.

Preferred optional substituents include alkyl, (e.g. C₁₋₆ alkyl such as methyl, ethyl, propyl, butyl, cyclopropyl, cyclobutyl, cyclopentyl or cyclohexyl), hydroxyalkyl (e.g. hydroxymethyl, hydroxyethyl, hydroxypropyl), alkoxyalkyl (e.g. methoxymethyl, methoxyethyl, methoxypropyl, ethoxymethyl, ethoxyethyl, ethoxypropyl etc) alkoxy (e.g. C₁₋₆ alkoxy such as methoxy, ethoxy, propoxy, butoxy, cyclopropoxy, cyclobutoxy), halo, trifluoromethyl, trichloromethyl, tribromomethyl, hydroxy, phenyl (which itself may be further substituted e.g., by C₁₋₆ alkyl, halo, hydroxy, hydroxyC₁₋₆ alkyl, C₁₋₆ alkoxy, haloC₁₋₆alkyl, cyano, nitro OC(O)C₁₋₆ alkyl, and amino), benzyl (wherein benzyl itself may be further substituted e.g., by C₁₋₆ alkyl, halo, hydroxy, hydroxyC₁₋₆alkyl, C₁₋₆ alkoxy, haloC₁₋₆ alkyl, cyano, nitro OC(O)C₁₋₆ alkyl, and amino), phenoxy (wherein phenyl itself may be further substituted e.g., by C₁₋₆ alkyl, halo, hydroxy, hydroxyC₁₋₆ alkyl, C₁₋₆ alkoxy, haloC₁₋₆ alkyl, cyano, nitro OC(O)C₁₋₆ alkyl, and amino), benzyloxy (wherein benzyl itself may be further substituted e.g., by C₁₋₆ alkyl, halo, hydroxy, hydroxyC₁₋₆ alkyl, C₁₋₆ alkoxy, haloC₁₋₆ alkyl, cyano, nitro OC(O)C₁₋₆ alkyl, and amino), amino, alkylamino (e.g. C₁₋₆ alkyl, such as methylamino, ethylamino, propylamino etc), dialkylamino (e.g. C₁₋₆ alkyl, such as dimethylamino, diethylamino, dipropylamino), acylamino (e.g. NHC(O)CH₃), phenylamino (wherein phenyl itself may be further substituted e.g., by C₁₋₆ alkyl, halo, hydroxy, hydroxyC₁₋₆ alkyl, C₁₋₆ alkoxy, haloC₁₋₆ alkyl, cyano, nitro OC(O)C₁₋₆ alkyl, and amino), nitro, formyl, —C(O)-alkyl (e.g. C₁₋₆ alkyl, such as acetyl), O—C(O)-alkyl (e.g. C₁₋₆alkyl, such as acetyloxy), benzoyl (wherein the phenyl group itself may be further substituted e.g., by C₁₋₆ alkyl, halo, hydroxy hydroxyC₁₋₆ alkyl, C₁₋₆ alkoxy, haloC₁₋₆ alkyl, cyano, nitro OC(O)C₁₋₆alkyl, and amino), replacement of CH₂ with C═O, CO₂H, CO₂alkyl (e.g. C₁₋₆ alkyl such as methyl ester, ethyl ester, propyl ester, butyl ester), CO₂phenyl (wherein phenyl itself may be further substituted e.g., by C₁₋₆ alkyl, halo, hydroxy, hydroxyl C₁₋₆ alkyl, C₁₋₆ alkoxy, halo C₁₋₆ alkyl, cyano, nitro OC(O)C₁₋₆ alkyl, and amino), CONH₂, CONHphenyl (wherein phenyl itself may be further substituted e.g., by C₁₋₆ alkyl, halo, hydroxy, hydroxyl C₁₋₆ alkyl, C₁₋₆ alkoxy, halo C₁₋₆ alkyl, cyano, nitro OC(O)C₁₋₆ alkyl, and amino), CONHbenzyl (wherein benzyl itself may be further substituted e.g., by C₁₋₆ alkyl, halo, hydroxy hydroxyl C₁₋₆ alkyl, C₁₋₆ alkoxy, halo C₁₋₆ alkyl, cyano, nitro OC(O)C₁₋₆ alkyl, and amino), CONHalkyl (e.g. C₁₋₆ alkyl such as methyl ester, ethyl ester, propyl ester, butyl amide) CONHdialkyl (e.g. C₁₋₆ alkyl) aminoalkyl (e.g., HN C₁₋₆ alkyl-, C₁₋₆alkylHN—C₁₋₆ alkyl- and (C₁₋₆ alkyl)₂N—C₁₋₆ alkyl-), thioalkyl (e.g., HS C₁₋₆ alkyl-), carboxyalkyl (e.g., HO₂CC₁₋₆ alkyl-), carboxyesteralkyl (e.g., C₁₋₆ alkylO₂CC₁₋₆ alkyl-), amidoalkyl (e.g., H₂N(O)CC₁₋₆ alkyl-, H(C₁₋₆ alkyl)N(O)CC₁₋₆ alkyl-), formylalkyl (e.g., OHCC₁₋₆alkyl-), acylalkyl (e.g., C₁₋₆ alkyl(O)CC₁₋₆ alkyl-), nitroalkyl (e.g., O₂NC₁₋₆ alkyl-), sulfoxidealkyl (e.g., R(O)SC₁₋₆ alkyl, such as C₁₋₆ alkyl(O)SC₁₋₆ alkyl-), sulfonylalkyl (e.g., R(O)₂SC₁₋₆ alkyl- such as C₁₋₆ alkyl(O)₂SC₁₋₆ alkyl-), sulfonamidoalkyl (e.g., ₂HRN(O)SC₁₋₆ alkyl, H(C₁₋₆ alkyl)N(O)SC₁₋₆ alkyl-), triarylmethyl, triarylamino, oxadiazole, and carbazole.

The invention will now be described with reference to the following non-limiting examples.

### EXAMPLES

### Example 1. Variety of Non-Core-Shell Polymer Particles by Continuous Emulsion Polymerization Process

### Example 1a. Preparation of a Poly-[(Butyl Acrylate)-Block-(Acrylic Acid)] Macro-RAFT Agent Containing an Average of 10 Monomer Units Per Chain in a Molar Ratio of 1:1 Using 2-{[(butylsulfanyl)carbonothioyl]sulfanyl} Propanoic Acid

2-{[(butylsulfanyl)carbonothioyl]sulfanyl} propanoic acid (1.9 g, 8.0 mmol), 2,2′-azobisisobutyronitrile (AIBN) (0.07 g, 0.4 mmol), acrylic acid (3.0 g, 41.0 mmol), in dioxane (10.0 g) was prepared in a 50 mL round bottom flask. This was stirred magnetically and purged with nitrogen for 10 minutes. The flask was then heated at 70° C. for 3 hours under constant stirring. To this polymer solution, butyl acrylate (5.3 g, 41.2 mmol) and AIBN (0.07 g, 0.4 mmol) was added. The flask was again sealed, purged with nitrogen for 10 minutes and further heated for another 3 hours under continuous magnetic stirring. The final copolymer solution had 55.9% solids.

### Example 1b. Synthesis of Polystyrene Seed Latex Using Macro-RAFT Agent from 1a

In a 1 L beaker, macro-RAFT solution from Example 1a (10.0 g) was dispersed in water (501.1 g) to yield a yellow dispersion. Ammonium hydroxide (28% solution in water) was added to the macro-RAFT solution to raise the pH to 9. The macro-RAFT copolymer was further dispersed by ultrasonication using an ultrasonic probe (Vibra-Cell Ultrasonic Processor, Sonics and Materials, Inc.) for 5 minutes at 30 percent amplitude to obtain a clear yellow solution at pH 8.5. The solution was transferred to a 1 L round bottom flask containing 4,4′-azobis(4-cyanovaleric acid) (V501) (0.2 g) which was subsequently sealed and purged with nitrogen for 15 minutes. The whole flask was then immersed in an oil bath with a temperature setting of 70° C. and was magnetically stirred. A deoxygenated styrene solution (25 mL, 22.7 g) was injected into the flask, while in the 70° C. oil bath, at a rate of 5 mL/hour. Upon completion of feeding, the heating was continued overnight to produce yellow latex containing polymer beads. The beads were subsequently removed by centrifugation, yielding semi-transparent yellow latex with 5.1% solids.

### Example 1c. Synthesis of Polystyrene Non-Core-Shell Polymer Particles Using Seed Latex from 1b

Latex from Example 1b (100.5 g) and water (150.0 g) was added to a 500 mL round bottom flask containing 4,4′-azobis(4-cyanovaleric acid) (V501) (0.2 g) and divinyl benzene (1.2 g). The flask was subsequently sealed and purged with nitrogen for 15 minutes. The whole flask was then immersed in an oil bath with a temperature setting of 70° C. and was magnetically stirred. After 1 hour of heating, a deoxygenated styrene solution (40 mL, 36.2 g) was injected into the flask, while in the 70° C. oil bath, at a rate of 10 mL/hour. Upon completion of feeding, the heating was continued overnight to produce yellow latex. The final latex had 15.1% solids and was found to contain non-core-shell polymer particles by transmission electron microscopy.

### Example 1d. Synthesis of Film Forming Poly(Methyl Methacrylate/Butyl Acrylate)/Polystyrene Non-Core-Shell Polymer Particles Using Seed Latex from 1b

Latex from Example 1b (100.5 g) and water (150.6 g) was added to a 500 mL round bottom flask containing 4,4′-azobis(4-cyanovaleric acid) (V501) (0.2 g) and divinyl benzene (0.7 g). The flask was subsequently sealed and purged with nitrogen for 15 minutes. The whole flask was then immersed in an oil bath with a temperature setting of 70° C. and was magnetically stirred. After 1 hour of heating, a deoxygenated methyl methacrylate (MMA)/butyl acrylate (BA) solution (1:1 by weight) (40 mL, 36.7 g) was injected into the flask, while in the 70° C. oil bath, at a rate of 10 mL/hour. Upon completion of feeding, the heating was continued overnight to produce yellow latex. The final latex had 14.9% solids and was found to contain non-core-shell polymer particle by transmission electron microscopy.

### Example 1e. Synthesis of Poly(Trifluoroethyl Methacrylate) Lobe/Polystyrene Seed Non-Core-Shell Polymer Particles Using Seed Latex from 1b

Latex from Example 1b (20.0 g) and water (30.0 g) was added to a 100 mL round bottom flask containing 4,4′-azobis(4-cyanovaleric acid) (V501) (0.03 g) and divinyl benzene (0.13 g). The flask was subsequently sealed and purged with nitrogen for 10 minutes. The whole flask was then immersed in an oil bath with a temperature setting of 70° C. and was magnetically stirred. After 1 hour of heating, a deoxygenated 2,2,2-trifluoroethyl methacrylatestyrene (TFEMA) solution (8 mL, 9.4 g) was injected into the flask, while in the 70° C. oil bath, at a rate of 2 mL/hour. Upon completion of feeding, the heating was continued overnight to produce yellow latex. The final latex had 18.1% solids and was found to contain non-core-shell polymer particle by transmission electron microscopy.

### Example 1f. Synthesis of Polystyrene Multilobed Non-Core-Shell Polymer Particles Using Non-Core-Shell Polymer Particles from Example 1c as Seed Latex

Latex from Example 1c (10.3 g), sodium dodecyl sulphate (SDS) (0.03 g) and water (40.5 g) was added to a 100 mL round bottom flask containing 4,4′-azobis(4-cyanovaleric acid) (V501) (0.025 g) and divinyl benzene (0.21 g). The flask was subsequently sealed and purged with nitrogen for 15 minutes. The whole flask was then immersed in an oil bath with a temperature setting of 70° C. and was magnetically stirred. After 1 hour of heating, a deoxygenated styrene solution (2.5 mL, 2.3 g) was injected into the flask, while in the 70° C. oil bath, at a rate of 2.5 mL/hour. Upon completion of feeding, the heating was continued for another 4 hours to produce a white latex. The final latex had 7.4% solids and was found to contain multilobed non-core-shell polymer particle by transmission electron microscopy.

### Example 2. Coating of TiO₂

### Example 2a. Dispersion and Encapsulation of Titanium Dioxide R706 (Tipure, Chemours) Using Poly(Methyl Methacrylate-Co-Butyl Acrylate)/Polystyrene Non-Core-Shell Polymer Particles from 1d

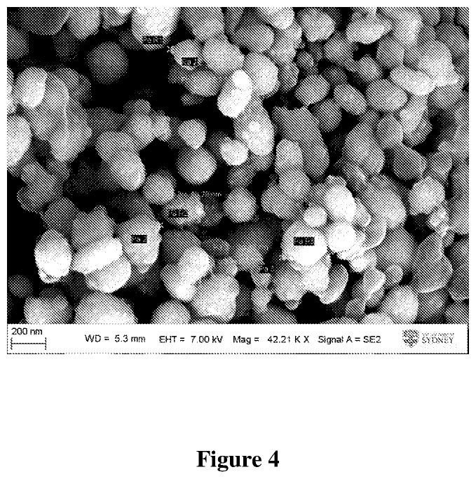

Non-core-shell polymer particle latex from Example 1d (5.3 g) and water (10.3 g) was added and mixed in a 25 mL vial. Titanium dioxide (1 g) was added and mixed under constant magnetic stirring to produce a white dispersion. The dispersion was further dispersed for 1 minute using an ultrasonic probe Vibra-Cell Ultrasonic Processor (Sonics and Materials, Inc.). After the sonication, 1 g of Sodium dodecyl sulphate (SDS) solution (2%) was added to the dispersion. This was followed by the slow addition of 0.1 M HCl solution under constant magnetic stirring to lower the dispersion pH to 4. The white dispersion was further thoroughly dispersed with another minute of ultrasonication. The final products were found to contain Titanium dioxide particles coated with polymer non-core-shell polymer particles as shown FIG. 4.

### Example 2b. Dispersion and Encapsulation of Titanium Dioxide R706 (Tipure, Chemours) Using Poly(Methyl Methacrylate-Co-Butyl Acrylate)/Polystyrene Non-Core-Shell Polymer Particles from 1d

Non-core-shell polymer particle latex from Example 1d (15 g) and Titanium dioxide (1 g) was added and mixed in a 25 mL vial. 1 g of sodium dodecyl sulfate (SDS) solution (2%) was added to the dispersion under constant magnetic stirring to produce a white dispersion. The dispersion was further dispersed for 5 minutes using an ultrasonic probe Vibra-Cell Ultrasonic Processor (Sonics and Materials, Inc.) to produce a white dispersion. This was followed by the slow addition of 0.1 M HCl solution under constant magnetic stirring to lower the dispersion pH to 6. The final product was found to contain Titanium dioxide particles coated with polymer non-core-shell polymer particles.

### Example 3. Coating and UV Protection of Phthalocyanine Blue

### Example 3. Dispersion and Encapsulation of Phthalocyanine Blue Pigment L7081D (BASF) Using Polystyrene Non-Core-Shell Polymer Particles from 1c. Benzophenone was Used as the UV Absorber to Prevent Photo-Degradation of the Pigment Under the UV Light

Non-core-shell polymer particle latex from Example 1c (10.37 g) and ASE-60 solution (25.55 g, 2.8%, pH 7.5) was added and mixed for 1 minute in a 25 mL vial. To this latex, a toluene (5.05 g) solution containing benzophenone (0.06 g) and blue pigment (0.57 g) was added and mixed thoroughly. The dispersion was further dispersed for 1 minute using an ultrasonic probe Vibra-Cell Ultrasonic Processor (Sonics and Materials, Inc.). After the sonication, 0.06 g of sodium dodecyl sulfate (SDS) was added to the dispersion. This was followed by another minute of ultrasonication to produce a blue dispersion.

### Example 4. Coating of Phthalocyanine Blue Using AIBN as Initiator

### Example 4. Dispersion and Encapsulation of Phthalocyanine Blue Pigment L7081D (BASF) Using Polystyrene Non-Core-Shell Polymer Particles from 1c. Styrene and 2,2′-Azobisisobutyronitrile (AIBN) was Added for Further Polymerization

Non-core-shell polymer particle latex from Example 1c (10.0 g) and ASE-60 solution (25.0 g, 2.8%, pH 7.5) was added and mixed for 1 minute in a 25 mL vial. To this latex, a styrene (5.02 g) solution containing 2,2′-azobisisobutyronitrile (AIBN) (0.06 g) and blue pigment (0.57 g) was added and mixed thoroughly. The dispersion was further dispersed for 1 minute using an ultrasonic probe Vibra-Cell Ultrasonic Processor (Sonics and Materials, Inc.). After the sonication, 0.06 g of sodium dodecyl sulfate (SDS) was added to the dispersion. This was followed by another minute of ultrasonication to produce a blue dispersion. The dispersion was transferred to a round bottom flask and sealed with a rubber septum. After 10 minutes of nitrogen purging, the flask was heated in an oil bath at 70° C. under constant magnetic stirring for 3 hours. After the polymerization, the sample was filtered to produce a blue dispersion which was found to contain polymer encapsulated blue pigment particles.

### Example 5. Coating of Coral Red Pigment

### Example 5. Dispersion and Encapsulation of Cromophtal DPP Coral Red C Pigment (CIBA) Using Poly(Methyl Methacrylate/Butyl Acrylate)/Polystyrene Non-Core-Shell Polymer Particles from 1d

Non-core-shell polymer particle latex from Example 1d (9.91 g) and ASE-60 solution (26.13 g, 2.8%, pH 7.5) was added and mixed for 1 minute in a 25 mL vial. To this latex, red pigment (0.57 g) was added and mixed thoroughly. The dispersion was further dispersed for 10 minutes using an ultrasonic probe Vibra-Cell Ultrasonic Processor (Sonics and Materials, Inc.) to produce a red dispersion. The final latex was found to contain polymer encapsulated pigment particles.

### Example 6. Non-Core-Shell Polymer Particles from Dibenzyl Trithiocarbonate RAFT Agent

### Example 6a. Preparation of a Poly-[(Styrene)-Block-(Poly(Butyl Acrylate-Co-Acrylic Acid)] Macro-RAFT Agent Containing an Average of 260 Monomer Units Per Chain in a Molar Ratio of 80:120:60 Using Dibenzyl Trithiocarbonate (DBTC)

Macro-RAFT Triblock was synthesized as follows: RAFT DBTC (0.6 g, 2.1 mmol), AIBN (0.08 g, 0.5 mmol), acrylic acid (9.2 g, 127.3 mmol), butyl acrylate (32.6 g, 254.6 mmol) in dioxane (40.0 g) was prepared in a 100 mL round bottom flask. This was stirred magnetically and purged with nitrogen for 10 minutes. The flask was then heated at 70° C. for 2.5 hours under constant stirring. At the end of the heating, styrene (17.7 g, 170 mmol), AIBN (0.1 g, 0.6 mmol) was added to the polymer solution. The flask was sealed, deoxygenated with nitrogen for 15 minutes and then heated at 70° C. for another 12 hours under constant stirring. The final copolymer solution had 53% solids.

### Example 6b. Synthesis of Crosslinked Polystyrene Seed Latex Using Macro-RAFT Agent from 6a

In a 1 L beaker, macro-RAFT solution from Example 6a (10.0 g) was dispersed in water (500.0 g) containing ammonium hydroxide (1.6 g, 25% in water) to yield a yellow solution with pH 9. Styrene (25 g, 240 mmol), DVB (2.5 g, 80%) was added to the macro-RAFT solution and thoroughly dispersed by a mechanical stirrer to obtain yellow emulsion. The emulsion was transferred to a 1 L round bottom flask containing 4,4′-azobis(4-cyanovaleric acid) (V501) (0.15 g) which was subsequently sealed and purged with nitrogen for 15 minutes. The whole flask was then immersed in an oil bath with a temperature setting of 70° C. and was magnetically stirred. The reaction was carried out in 12 hours to produce yellow latex with 6.2% solids and average particle size of 56 nm (Zetasizer, Malvern Instrument).

### Example 6c. Synthesis of Film Forming Poly(Methyl Methacrylate-Co-Butyl Acrylate)/Polystyrene Non-Core-Shell Polymer Particles Using Seed Latex from 6b

Latex from Example 6b (301 g) and water (301 g) was added to a 1 L round bottom flask containing 4,4′-azobis(4-cyanovaleric acid) (V501) (0.6 g). The flask was subsequently sealed and purged with nitrogen for 10 minutes. The whole flask was then immersed in an oil bath with a temperature setting of 70° C. and was magnetically stirred. A deoxygenated methyl methacrylate (MMA)/butyl acrylate (BA) solution (1:1 by weight) (50 mL, 45.9 g) was injected into the flask, while in the 70° C. oil bath, at a rate of 20 mL/hour. After 2.5 hours, another 70 mL monomer solution of MMA/BA (1:1) was injected into the flask at a rate of 35 mL/hour. Upon completion of feeding, the heating was continued overnight to produce white latex. The final latex had 17.5% solids with an average particle size of 93 nm (Zetasizer, Malvern Instrument) and was found to contain film forming non-core-shell polymer particles.

### Example 6d. Dispersion and Encapsulation of Titanium Dioxide R706 (Tipure, Chemours) Using Poly(Methyl Methacrylate-Co-Butyl Acrylate)/Polystyrene Non-Core-Shell Polymer Particles from 6c

Non-core-shell polymer particle latex from Example 6c (30 g) was mixed with propylene glycol (8 g) and Teric 164 (0.3 g) to produce a dispersion. Titanium dioxide (20 g) was then added to the latex dispersion and thoroughly mixed using a mechanical stirrer for 5 mins at 1500 rpm to produce a white dispersion. The final product was found to contain Titanium dioxide particles coated with polymer non-core-shell polymer particles.

### Example 6e. Dispersion and Encapsulation of Omyacarb 10 Using Poly(Methyl Methacrylate-Co-Butyl Acrylate)/Polystyrene Non-Core-Shell Polymer Particles from 6c

Non-core-shell polymer particle latex from Example 6c (30.0 g), propylene glycol (8.5 g) and Teric164 (0.3 g) was mixed in a beaker. To this mixture, Omyacarb 10 (20.8 g, Omya Australia) was added and mixed for 5 minutes using a mechanical stirrer at 1500 rpm to produce a viscous white dispersion. The dispersion was found to contain polymer coated Calcite particles by transmission electron microscopy.

### Example 7. Non-Core-Shell Polymer Particle Synthesis and Encapsulation of Pigment Particles Using 2-{[(Dodecylsulfanyl)Carbonothioyl]Sulfanyl} Propanoic Acid (DOPAT) RAFT Agent

### Example 7a. Preparation of a Poly(Acrylic Acid) Macro-RAFT Agent Containing an Average of 5 Monomer Units Per Chain Using 2-{[(Dodecylsulfanyl)Carbonothioyl]Sulfanyl} Propanoic Acid

2-{[(dodecylsulfanyl)carbonothioyl]sulfanyl} propanoic acid (7.44 g, 21.2 mmol), 2,2′-azobisisobutyronitrile (AIBN) (0.19 g, 1.1 mmol), acrylic acid (7.9 g, 109.0 mmol), in dioxane (30.2 g) was prepared in a 100 mL round bottom flask. This was stirred magnetically and purged with nitrogen for 10 minutes. The flask was then heated at 70° C. for 5 hours under constant stirring. The final polymer solution had 29.9% solids.

### Example 7b. Synthesis of Polystyrene Seed Latex Using Macro-RAFT Agent from 7a

In a 1 L beaker, macro-RAFT solution from Example 7a (9.9 g) was dispersed in water (500.0 g) to yield a clear yellow solution. Ammonium hydroxide (28% solution in water) was added to the macro-RAFT solution to raise the pH to 8.5. The solution was transferred to a 1 L round bottom flask containing 4,4′-azobis(4-cyanovaleric acid) (V501) (0.49 g) which was subsequently sealed and purged with nitrogen for 15 minutes. The whole flask was then immersed in an oil bath with a temperature setting of 70° C. and was magnetically stirred. A deoxygenated styrene solution (25 mL, 22.7 g) was injected into the flask, while in the 70° C. oil bath, at a rate of 5 mL/hour. Upon completion of feeding, the heating was continued overnight to produce yellow latex containing polymer beads. The beads were subsequently removed by centrifugation, yielding semi-transparent yellow latex with 4.4% solids and particle sizes of 39 nm (measured by Zetasizer, Malvern Instrument).

### Example 7c. Synthesis of Polystyrene Non-Core-Shell Polymer Particles Using Seed Latex from 7b

Latex from Example 7b (101.1 g) and water (149.8 g) was added to a 500 mL round bottom flask containing 4,4′-azobis(4-cyanovaleric acid) (V501) (0.2 g) and divinyl benzene (1.3 g). The flask was subsequently sealed and purged with nitrogen for 15 minutes. The whole flask was then immersed in an oil bath with a temperature setting of 70° C. and was magnetically stirred. After 1 hour of heating, a deoxygenated styrene solution (40 mL, 36.2 g) was injected into the flask, while in the 70° C. oil bath, at a rate of 10 mL/hour. Upon completion of feeding, the heating was continued overnight to produce yellow latex. The final latex had 15.7% solids and was found to contain non-core-shell polymer particle by transmission electron microscopy. Particle sizes of 48 nm were measured by dynamic light scattering (Zetasizer, Malvern Instrument).

### Example 7d. Synthesis of Film Forming Poly(Methyl Methacrylate-Co-Butyl Acrylate)/Polystyrene Non-Core-Shell Polymer Particles Using Seed Latex from 7b

Latex from Example 7b (100.2 g) and water (150.5 g) was added to a 500 mL round bottom flask containing 4,4′-azobis(4-cyanovaleric acid) (V501) (0.2 g) and divinyl benzene (1.2 g). The flask was subsequently sealed and purged with nitrogen for 15 minutes. The whole flask was then immersed in an oil bath with a temperature setting of 70° C. and was magnetically stirred. After 1 hour of heating, a deoxygenated methyl methacrylate (MMA)/butyl acrylate (BA) solution (1:1 by weight) (40 mL, 36.7 g) was injected into the flask, while in the 70° C. oil bath, at a rate of 10 mL/hour. Upon completion of feeding, the heating was continued overnight to produce yellow latex. The final latex had 14.5% solids and was found to contain non-core-shell polymer particle by transmission electron microscopy. Particle sizes of 58 nm were measured by dynamic light scattering (Zetasizer, Malvern Instrument).

### Example 8. Coating of Omyacarb 10 Using Non-Core-Shell Polymer Particles from Example 7

### Example 8a. Dispersion and Encapsulation of Omyacarb 10 Using Poly(Methyl Methacrylate-Co-Butyl Acrylate)/Polystyrene Non-Core-Shell Polymer Particles from 7d

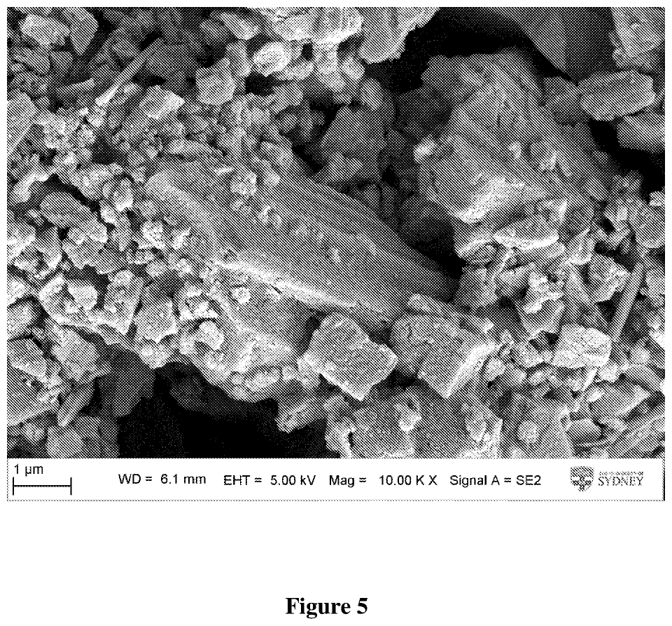

Non-core-shell polymer particle latex from Example 7d (29.1 g) and Orotan 731A (2.1 g) was added and mixed in a 100 mL beaker. The mixture pH was adjusted to 7 using a 0.1 M HCl solution. After pH adjustment, Omyacarb 10 (20.3 g) was added and mixed under constant magnetic stirring to produce a white dispersion. The dispersion was further dispersed for 1 minute using an ultrasonic probe Vibra-Cell Ultrasonic Processor (Sonics and Materials, Inc.). After the sonication, 0.1 M CaCl₂) solution (2.6 g) was then slowly added under constant magnetic stirring. The white dispersion was further thoroughly dispersed with another minute of ultrasonication. The final product was found to contain Calcite particles coated with polymer non-core-shell polymer particles as shown in FIG. 5.

### Example 8b. Dispersion of Omyacarb 10 Using Polystyrene Non-Core-Shell Polymer Particles from 7c

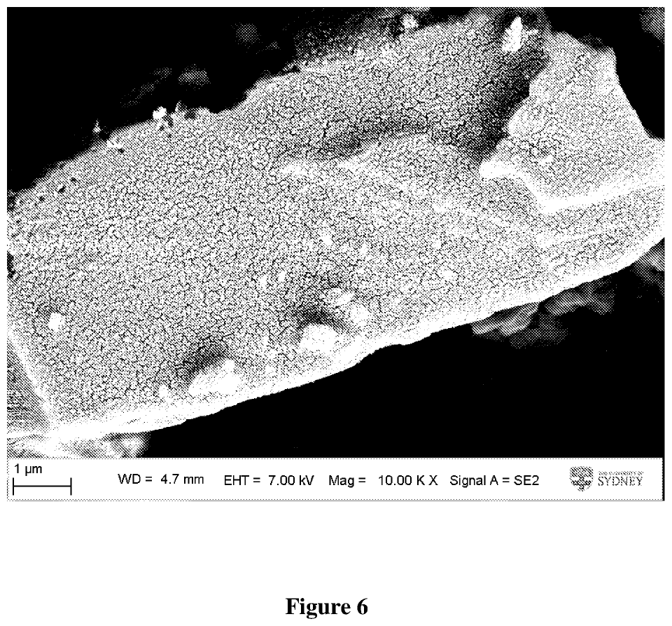

Non-core-shell polymer particle latex from Example 7c (30.7 g) and Orotan 731A (2.0 g) was added and mixed in a 100 mL beaker. The mixture pH was adjusted to 7.5 using a 0.1 M HCl solution. After pH adjustment, Omyacarb 10 (20.0 g) was added and mixed under constant magnetic stirring to produce a white dispersion. The dispersion was further dispersed for 1 minute using an ultrasonic probe Vibra-Cell Ultrasonic Processor (Sonics and Materials, Inc.). After the sonication, 0.1 M CaCl₂) solution (2.6 g) was then slowly added under constant magnetic stirring. The white dispersion was further thoroughly dispersed with another minute of ultrasonication. The final products were found to contain Calcite particles coated with polymer non-core-shell polymer particles as shown in FIG. 6.

### Example 9. DOPAT Film Forming Non-Core-Shell Polymer Particles—Large Batch

### Example 9a. Synthesis of Polystyrene Seed Latex Using Macro-RAFT Agent from 7a

In a 1 L beaker, macro-RAFT solution from Example 7a (10.1 g) was dispersed in water (500.0 g) to yield a clear yellow solution. Ammonium hydroxide (28% solution in water) was added to the macro-RAFT solution to raise the pH to 8.5. The solution was transferred to a 1 L round bottom flask containing 4,4′-azobis(4-cyanovaleric acid) (V501) (0.52 g) which was subsequently sealed and purged with nitrogen for 15 minutes. The whole flask was then immersed in an oil bath with a temperature setting of 70° C. and was magnetically stirred. A deoxygenated styrene solution (25 mL, 22.7 g) was injected into the flask, while in the 70° C. oil bath, at a rate of 5 mL/hour. Upon completion of feeding, the heating was continued overnight to produce yellow latex containing polymer beads. The beads were subsequently removed by centrifugation, yielding semi-transparent yellow latex with 4.5% solids and particle sizes of 15 nm (number average, measured by Zetasizer, Malvern Instrument).

### Example 9b. Synthesis of Film Forming Poly(Methyl Methacrylate-Co-Butyl Acrylate)/Polystyrene Non-Core-Shell Polymer Particles Using Seed Latex from 9a

Latex from Example 9a (300 g) and water (300 g) was added to a 1 L round bottom flask and the pH was adjusted to 7.4. To this flask, 4,4′-azobis(4-cyanovaleric acid) (V501) (0.67 g) and divinyl benzene (3.6 g) was added. The flask was subsequently sealed and purged with nitrogen for 15 minutes. The whole flask was then immersed in an oil bath with a temperature setting of 70° C. and was magnetically stirred. After 1 hour of heating, a deoxygenated methyl methacrylate (MMA)/butyl acrylate (BA) solution (1:1 by weight) (50 mL, 45.9 g) was injected into the flask, while in the 70° C. oil bath, at a rate of 20 mL/hour. Upon completion of feeding, another amount of deoxygenated methyl methacrylate (MMA)/butyl acrylate (BA) solution (1:1 by weight) (70 mL, 64.2 g) was injected into the flask, while in the 70° C. oil bath, at a rate of 35 mL/hour. The heating was continued overnight to produce yellow latex. After filtering with 80 micron mesh, the final latex had 17.6% solids. Particle sizes of 70 nm were measured by dynamic light scattering (Zetasizer, Malvern Instrument).

### Example 10. CaCl₂) and Texanol Enhanced Coating of Omyacarb 10

### Example 10a. Dispersion and Encapsulation of Omyacarb 10 Using Poly(Methyl Methacrylate-Co-Butyl Acrylate)/Polystyrene Non-Core-Shell Polymer Particles from 9b. CaCl₂) was Used as a Coalescing Agent

Non-core-shell polymer particle latex from Example 9b (30.11 g) and ASE-60 solution (2.8%, pH 7.5) (3.4 g) was mixed in a 150 mL beaker. To this mixture, Omyacarb 10 (20.3 g, Omya Australia) was added and mixed for 10 minutes using a mechanical stirrer at 1500 rpm to produce a viscous white dispersion. Under constant stirring (1500 rpm), a solution of 0.1 M CaCl₂ (2.5 g) was added dropwise to the white dispersion. The dispersion was further dispersed for 5 minutes at 1500 rpm. To this dispersion, Dulux Aquanamel Gloss latex (50.2 g, Dulux Australia) was added and the white dispersion was mixed at 1500 rpm for 10 minutes using a mechanical stirrer. The dispersion was further thoroughly dispersed using a high speed disperser (Miccra D9, Labortechnik) for another minute at 8000 rpm. The final product was applied to a Leneta card using a 50 micron drawdown bar to produce a wet white film. The film was left in an oven at 50° C. for 24 hours to produce a dry polymer film. The Blue food dye stain was applied on the film in the form of paper towel stripe (1×3 cm) for 1 hour. After 1 hour, the stain was wiped first using dry paper towel and then 3 times by a combination of Spray and Wipe (Ocean Fresh) and paper towel. It was observed that most of Blue food stain was removed.

### Example 10b. Dispersion and Encapsulation of Omyacarb 10 Using Poly(Methyl Methacrylate-Co-Butyl Acrylate)/Polystyrene Non-Core-Shell Polymer Particles from 9b. Texanol was Used as a Coalescing Agent

Non-core-shell polymer particle latex from Example 9b (29.9 g) and ASE-60 solution (2.8%, pH 7.5) (3.3 g) was mixed in a 150 mL beaker. To this mixture, Omyacarb 10 (20.7 g, Omya Australia) was added and mixed for 10 minutes using a mechanical stirrer at 1500 rpm to produce a viscous white dispersion. Under constant stirring (1500 rpm), a solution of Texanol (0.5 g) was added dropwise to the white dispersion. The dispersion was further dispersed for 5 minutes at 1500 rpm. To this dispersion, Dulux Aquanamel Extra Bright Base (50.0 g, Dulux Australia) was added and the white dispersion was mixed at 1500 rpm for 10 minutes using a mechanical stirrer. The dispersion was further thoroughly dispersed using a high-speed disperser (Miccra D9, Labortechnik) for another minute at 8000 rpm. The final product was applied to a Leneta card using a 50 micron drawdown bar to produce a wet white film. The film was left in an oven at 50° C. for 24 hours to produce a dry polymer film. The Blue food dye stain was applied on the film in the form of paper towel stripe (1×3 cm) for 1 hour. After 1 hour, the stain was wiped first using dry paper towel and then 3 times by a combination of Spray and Wipe (Ocean Fresh) and paper towel. It was observed that most of Blue food stain was removed.

### Example 11. Non-Core-Shell Polymer Particles Using 2-{[(Butylsulfanyl)Carbonothioyl]Sulfanyl} Propanoic Acid (BUPAT)

### Example 11a. Preparation of a Poly-[(Butyl Acrylate)-Block-(Acrylic Acid)] Macro-RAFT Agent Containing an Average of 10 Monomer Units Per Chain in a Molar Ratio of 1:1 Using 2-{[(Butylsulfanyl)Carbonothioyl]Sulfanyl} Propanoic Acid

2-{[(butylsulfanyl)carbonothioyl]sulfanyl} propanoic acid (1.45 g, 6.0 mmol), 2,2′-azobisisobutyronitrile (AIBN) (0.05 g, 0.3 mmol), acrylic acid (2.23 g, 30.5 mmol), in dioxane (10.0 g) was prepared in a 50 mL round bottom flask. This was stirred magnetically and purged with nitrogen for 10 minutes. The flask was then heated at 70° C. for 3 hours under constant stirring. To this polymer solution, butyl acrylate (3.9 g, 30.5 mmol) and AIBN (0.05 g, 0.3 mmol) was added. The flask was again sealed, purged with nitrogen for 10 minutes and further heated for another 3 hours under continuous magnetic stirring. The final copolymer solution had 48.5% solids.

### Example 11b. Synthesis of Polystyrene Seed Latex Using Macro-RAFT Agent from 11a

In a 1 L beaker, macro-RAFT solution from Example 11a (10.0 g) was dispersed in water (499.3 g) to yield a yellow dispersion. Ammonium hydroxide (28% solution in water) was added to the macro-RAFT solution to raise the pH to 8.5 producing a clear yellow solution. The solution was transferred to a 1 L round bottom flask containing 4,4′-azobis(4-cyanovaleric acid) (V501) (0.2 g) which was subsequently sealed and purged with nitrogen for 10 minutes. The whole flask was then immersed in an oil bath with a temperature setting of 70° C. and was magnetically stirred. A deoxygenated styrene solution (25 mL, 22.7 g) was injected into the flask, while in the 70° C. oil bath, at a rate of 5 mL/hour. Upon completion of feeding, the heating was continued overnight to produce yellow latex containing a small amount of polymer beads. The beads were subsequently removed by centrifugation, yielding semi-transparent yellow latex with 5.2% solids. Particle sizes of 5 nm were measured by dynamic light scattering (Zetasizer, Malvern Instrument).

### Example 11c. Synthesis of Film Forming Poly(Methyl Methacrylate-Co-Butyl Acrylate)/Polystyrene Non-Core-Shell Polymer Particles Using Seed Latex from 11b

Latex from Example 11b (299 g) and water (300.8 g) was added to a 1 L round bottom flask containing 4,4′-azobis(4-cyanovaleric acid) (V501) (0.65 g). The latex pH was raised to 8 using ammonium hydroxide 28% which was then followed by an addition of divinyl benzene (3.6 g). The flask was subsequently sealed and purged with nitrogen for 10 minutes. The whole flask was then immersed in an oil bath with a temperature setting of 70° C. and was magnetically stirred. After 1 hour of heating, a deoxygenated methyl methacrylate (MMA)/butyl acrylate (BA) solution (1:1 by weight) (50 mL, 45.9 g) was injected into the flask, while in the 70° C. oil bath, at a rate of 20 mL/hour. Upon completion of feeding, another amount of deoxygenated methyl methacrylate (MMA)/butyl acrylate (BA) solution (1:1 by weight) (70 mL, 64.2 g) was injected into the flask, while in the 70° C. oil bath, at a rate of 35 mL/hour. The heating was continued overnight to produce yellow latex. After filtering with 80 micron mesh, the final latex had 17.8% solids. Particle sizes of 36 nm were measured by dynamic light scattering (Zetasizer, Malvern Instrument).

### Example 12. Coating of Omyacarb 10 Using Non-Core-Shell Polymer Particles from Example 11

### Example 12a. Dispersion and Encapsulation of Omyacarb 10 Using Poly(Methyl Methacrylate-Co-Butyl Acrylate)/Polystyrene Non-Core-Shell Polymer Particles from 11c. Dulux Aquanamel was Used for Film Forming

Non-core-shell polymer particle latex from Example 11c (30.0 g) and ASE-60 solution (2.8%, pH 7.5) (3.2 g) was mixed in a 150 mL beaker. To this mixture, Omyacarb 10 (20.1 g, Omya Australia) was added and mixed for 10 minutes using a mechanical stirrer at 1500 rpm to produce a viscous white dispersion. To this dispersion, Dulux Aquanamel Gloss latex (50.1 g, Dulux Australia) was added and the white dispersion was mixed at 1500 rpm for 10 minutes using a mechanical stirrer. The dispersion was further thoroughly dispersed using a high speed disperser (Miccra D9, Labortechnik) for another minute at 8000 rpm.

The final product was applied to a Leneta card using a 50 micron drawdown bar to produce a wet white film. The film was left in an oven at 50° C. for 24 hours to produce a dry polymer film. The Blue food dye (Queen Fine Foods) stain was applied on the film in the 5 form of paper towel stripe (1×3 cm) for 1 hour. After 1 hour, the stain was wiped first using dry paper towel and then 3 times by a combination of Spray and Wipe (Ocean Fresh) and paper towel. It was observed that most of Blue food dye stain was removed.

### Example 12b. Dispersion and Encapsulation of Omyacarb 10 Using Poly(Methyl Methacrylate-Co-Butyl Acrylate)/Polystyrene Non-Core-Shell Polymer Particles from 11c. CaCl₂) was Used as a Coalescing Agent. Dulux Aquanamel Extra Bright Base was Used for Film Forming

Non-core-shell polymer particle latex from Example 11c (30.1 g) and ASE-60 solution (2.8%, pH 7.5) (3.1 g) was mixed in a 150 mL beaker. To this mixture, Omyacarb 10 (20.2 g, Omya Australia) was added and mixed for 10 minutes using a mechanical stirrer at 1500 rpm to produce a viscous white dispersion. Under constant stirring (1500 rpm), a solution of 0.1 M CaCl₂) (2.5 g) was added dropwise to the white dispersion. The dispersion was further dispersed for 10 minutes at 1500 rpm. To this dispersion, Dulux Aquanamel Extra Bright Base (50.4 g, Dulux Australia) was added and the white dispersion was mixed at 1500 rpm for 10 minutes using a mechanical stirrer. The dispersion was further thoroughly dispersed using a high speed disperser (Miccra D9, Labortechnik) for another minute at 8000 rpm. The final product was applied to a Leneta card using a 50 micron drawdown bar to produce a wet white film. The film was left in an oven at 50° C. for 24 hours to produce a dry polymer film. The Blue food dye (Queen Fine Foods) stain was applied on the film in the form of paper towel stripe (1×3 cm) for 1 hour. After 1 hour, the stain was wiped first using dry paper towel and then 3 times by a combination of Spray and Wipe (Ocean Fresh) and paper towel. It was observed that most of Blue food dye stain was removed.

### Example 12c. Dispersion and Encapsulation of Omyacarb 10 Using Poly(Methyl Methacrylate-Co-Butyl Acrylate)/Polystyrene Non-Core-Shell Polymer Particles from 11c. Texanol was Used as a Coalescing Agent. Dulux Aquanamel Extra Bright Base was Used for Film Forming

Non-core-shell polymer particle latex from Example 11c (30.2 g) and ASE-60 solution (2.8%, pH 7.5) (3.7 g) was mixed in a 150 mL beaker. To this mixture, Omyacarb 10 (20.0 g, Omya Australia) was added and mixed for 10 minutes using a mechanical stirrer at 1500 rpm to produce a viscous white dispersion. Under constant stirring (1500 rpm), a solution of Texanol (1.0 g) was added dropwise to the white dispersion. The dispersion was further dispersed for 5 minutes at 1500 rpm. To this dispersion, Dulux Aquanamel Extra Bright Base (50.5 g, Dulux Australia) was added and the white dispersion was mixed at 1500 rpm for 10 minutes using a mechanical stirrer. The dispersion was further thoroughly dispersed using a high speed disperser (Miccra D9, Labortechnik) for another minute at 8000 rpm. The final product was applied to a Leneta card using a 50 micron drawdown bar to produce a wet white film. The film was left in an oven at 50° C. for 24 hours to produce a dry polymer film. The Blue food dye (Queen Fine Foods) stain was applied on the film in the form of paper towel stripe (1×3 cm) for 1 hour. After 1 hour, the stain was wiped first using dry paper towel and then 3 times by a combination of Spray and Wipe (Ocean Fresh) and paper towel. It was observed that most of Blue food dye stain was removed.

### Example 12d. Dispersion and Encapsulation of Omyacarb 10 Using Poly(Methyl Methacrylate-Co-Butyl Acrylate)/Polystyrene Non-Core-Shell Polymer Particles from 11c. BASF Acronal Eco 7603 Latex was Used for Film Forming

Non-core-shell polymer particle latex from Example 11c (30.0 g) and Omyacarb 10 (20.1 g, Omya Australia) was mixed in a 150 mL beaker. The mixture was further blended for 10 minutes using a mechanical stirrer at 1500 rpm to produce a viscous white dispersion. 1 g of SDS solution (2%) was further added and mixed at 1500 rpm for another minute. To this dispersion, BASF Acronal Eco 7603 (51 g, BASF) was added and the white dispersion was mixed at 1500 rpm for 10 minutes using a mechanical stirrer. The final product was applied to a Leneta card using a 50 micron drawdown bar to produce a wet white film. The film was left in an oven at 50° C. for 24 hours to produce a dry polymer film. The Blue food dye (Queen Fine Foods) stain was applied on the film in the form of paper towel stripe (1×3 cm) for 1 hour. After 1 hour, the stain was wiped first using dry paper towel and then 3 times by a combination of Spray and Wipe (Ocean Fresh) and paper towel. It was observed that most of Blue food dye stain was removed.

### Example 13. High Solid Content Film Forming Non-Core-Shell Polymer Particle Latex Using 2-{[(Butylsulfanyl)Carbonothioyl]Sulfanyl} Propanoic Acid (BUPAT)

### Example 13a. Preparation of a Poly-[(Butyl Acrylate)-Block-(Acrylic Acid)] Macro-RAFT Agent Containing an Average of 10 Monomer Units Per Chain in a Molar Ratio of 1:1 Using 2-{[(Butylsulfanyl)Carbonothioyl]Sulfanyl} Propanoic Acid

2-{[(butylsulfanyl)carbonothioyl]sulfanyl} propanoic acid (7.7 g, 32.2 mmol), 2,2′-azobisisobutyronitrile (AIBN) (0.27 g, 1.6 mmol), acrylic acid (11.6 g, 161.5 mmol), in dioxane (40 g) was prepared in a 250 mL round bottom flask. This was stirred magnetically and purged with nitrogen for 10 minutes. The flask was then heated at 70° C. for 3 hours under constant stirring. To this polymer solution, butyl acrylate (20.7 g, 161.6 mmol) and AIBN (0.27 g, 1.6 mmol) was added. The flask was again sealed, purged with nitrogen for 10 minutes and further heated for another 3 hours under continuous magnetic stirring. The final copolymer solution had 52.2% solids.

### Example 13b. Synthesis of Polystyrene Seed Latex Using Macro-RAFT Agent from 13a

In a 1 L beaker, macro-RAFT solution from Example 13a (20.0 g) was dispersed in water (500.0 g) to yield a yellow dispersion. Ammonium hydroxide (25% solution in water) was added to the macro-RAFT solution to raise the pH to 9.3 producing a clear yellow solution. The solution was transferred to a 1 L round bottom flask containing 4,4′-azobis(4-cyanovaleric acid) (V501) (0.3 g) which was subsequently sealed and purged with nitrogen for 10 minutes. The whole flask was then immersed in an oil bath with a temperature setting of 70° C. and was magnetically stirred. A deoxygenated styrene solution (50 mL, 45.3 g) was injected into the flask, while in the 70° C. oil bath, at a rate of 10 mL/hour. Upon completion of feeding, the heating was continued overnight to produce yellow latex containing a small amount of polymer beads. The beads were subsequently removed by centrifugation, yielding semi-transparent yellow latex with 9.2% solids. Particle sizes of 5 nm were measured by dynamic light scattering (Zetasizer, Malvern Instrument).

### Example 13c. Synthesis of Film Forming Poly(Methyl Methacrylate-Co-Butyl Acrylate)/Polystyrene Non-Core-Shell Polymer Particles Using Seed Latex from 13b

Latex from Example 13b (251 g) was added to a 1 L round bottom flask containing 4,4′-azobis(4-cyanovaleric acid) (V501) (0.6 g) which was then followed by an addition of divinyl benzene (6.6 g). The flask was subsequently sealed and purged with nitrogen for 10 minutes. The whole flask was then immersed in an oil bath with a temperature setting of 70° C. and was magnetically stirred. After 1 hour of heating, a deoxygenated methyl methacrylate (MMA)/butyl acrylate (BA) solution (1:1 by weight) (50 mL, 45.9 g) was injected into the flask, while in the 70° C. oil bath, at a rate of 25 mL/hour. Upon completion of feeding, 7.5 g of 2% sodium dodecyl sulphate (SDS) solution was added. Another amount of deoxygenated methyl methacrylate (MMA)/butyl acrylate (BA) solution (1:1 by weight) (70 mL, 64.2 g) was injected into the flask, while in the 70° C. oil bath, at a rate of 35 mL/hour. The heating was continued overnight to produce yellow latex. After filtering with 80 micron mesh, the final latex had 37.7% solids. Particle sizes of 70 nm were measured by dynamic light scattering (Zetasizer, Malvern Instrument).

### Example 13d. Synthesis of Film Forming Poly(Methyl Methacrylate-Co-Butyl Acrylate)/Polystyrene Non-Core-Shell Polymer Particles Using Seed Latex from 13b

Film forming non-core-shell polymer particle latex was synthesized in the same manner as in Example 13c. The final latex had 37.1% solids and contained particle with an average size of 66 nm as measured by dynamic light scattering (Zetasizer, Malvern Instrument).

### Example 14. Dispersion and Encapsulation of Omyacarb 10 Using Poly(Methyl Methacrylate-Co-Butyl Acrylate)/Polystyrene Non-Core-Shell Polymer Particles from 13d. BASF Acronal Eco 7603 Latex was Used for Film Forming

non-core-shell polymer particle latex from Example 13d (15.0 g) and Omyacarb 10 (20.0 g, Omya Australia) was mixed in a 150 mL beaker. The mixture was further blended for 10 minutes using a mechanical stirrer at 1500 rpm to produce a viscous white dispersion. 1 g of SDS solution (2%) was further added and mixed at 1500 rpm for another minute. To this dispersion, BASF Acronal Eco 7603 (50 g, BASF) was added and the white dispersion was mixed at 1500 rpm for 10 minutes using a mechanical stirrer. The final product was applied to a Leneta card using a 50 micron drawdown bar to produce a wet white film. The film was left in an oven at 50° C. for 24 hours to produce a dry polymer film. The Blue food dye (Queen Fine Foods) stain was applied on the film in the form of paper towel stripe (1×3 cm) for 1 hour. After 1 hour, the stain was wiped first using dry paper towel and then 3 times by a combination of Spray and Wipe (Ocean Fresh) and paper towel. It was observed that most of Blue food dye stain was removed.

### Example 15. Polymer Coating of Various Materials Using Film Forming Non-Core-Shell Polymer Particle Latex from Example 13c

### Example 15a. Polymer Coating of Chalks (1×8 cm, Calcium Carbonate) Using Film Forming Non-Core-Shell Polymer Particle Latex from Example 13c

Chalks (1×8 cm) were dipped into a glass jar containing 100 g of non-core-shell polymer particle latex from Example 13c. Once dried, uniform polymer coating on the chalks was observed with approximate thickness between 45-65 microns.

A chalk was dipped into the non-core-shell polymer particle latex then washed by dipping in milli-Q water to remove unadsorbed particles. By SEM, uniform polymer coating on the chalk was observed with approximate thickness between 15-25 microns.

### Example 15b. Polymer Coating of Carbon Fibre Using Film Forming Non-Core-Shell Polymer Particle Latex from Example 13c

A polymer latex was prepared in a vial by mixing 5 g of non-core-shell polymer particle latex from Example 13c with 5 g water and 1 g ethanol. Carbon fibre (10 micron in diameter) was cut to sizes of approximately 2 cm in lengths. 0.1 g of these cut fibres was dipped in to the prepared latex, removed and washed with water then dried in vacuum. The carbon fibre was found to be coated with polymer by SEM.

### Example 15c. Polymer Coating of Glass Slide Cover (2.2×2.2 cm, Silica) Using Film Forming Non-Core-Shell Polymer Particle Latex from Example 13c

Glass slide covers (8×8 cm) were dipped into a glass jar containing 77 g of non-core-shell polymer particle latex from Example 13c. They were then washed by dipping in milli-Q water. By SEM, polymer coating on the glass covers was observed with approximate thickness between 500-600 nm.

### Example 15d. Polymer Coating of Benzoic Acid Flakes Using Film Forming Non-Core-Shell Polymer Particle Latex from Example 13c

Benzoic acid flakes (0.1 g) were mixed with non-core-shell polymer particle latex from Example 13c (2 g) by stirring. The flakes were then removed by filtering. By SEM, they were found to be polymer coated with approximate thickness between 26-63 microns.

### Example 15e. Polymer Coating of Barium Sulphate (0.25-2 Microns) Using Film Forming Non-Core-Shell Polymer Particle Latex from Example 13c

Barium sulphate powder (0.1 g) was mixed with non-core-shell polymer particle latex from Example 13c (2 g) by stirring. The particles were then removed by centrifugation. By SEM, they were found to be polymer coated.

### Example 15f. Polymer Coating of Alumina (105 Microns) Using Film Forming Non-Core-Shell Polymer Particle Latex from Example 13c

Alumina powder (0.1 g) was mixed with non-core-shell polymer particle latex from Example 13c (4 g) by stirring. The particles were then removed by centrifugation. By SEM, they were found to be polymer coated.

### Example 15g. Polymer Coating of Glass Beads (2 mm, Glass) Using Film Forming Non-Core-Shell Polymer Particle Latex from Example 13c

Glass beads (1 g) was mixed with non-core-shell polymer particle latex from Example 13c (4 g) by stirring. The particles were then removed by filtering then washed with water to remove unadsorbed latex particles. By SEM, they were found to be polymer coated with thickness between 200 nm to 1 micron.

### Example 15h. Polymer Coating of Carbonyl Iron Particle (1-2 Microns) Using Film Forming Non-Core-Shell Polymer Particle Latex from Example 13c

Carbonyl iron (0.5 g) was mixed with non-core-shell polymer particle latex from Example 13c (3 g) by stirring. The particle was then removed by filtering and washed twice with DI water followed by drying under reduce pressure at room temperature. Good polymer coating was observed on the surface of the carbonyl iron particle using SEM.

### Example 15i. Polymer Coating of Zirconium Silicate Bead (0.8-1 mm) Using Film Forming Non-Core-Shell Polymer Particle Latex from Example 13c

Zirconium silicate bead was washed with acetone to remove contaminants on the surface and dried before used. The zirconium silicate bead (1 g) was mixed with non-core-shell polymer particle latex from Example 13c (3 g) by stirring. The bead was then removed by filtering and washed with DI water twice followed by drying under reduce pressure at room temperature. Good polymer coating was observed on the surface of the bead using SEM.

### Example 16. Non-Core-Shell Polymer Particles with No Charge on the Lobes

### Example 16 a. Synthesis of Polystyrene Seed Latex Using Macro-RAFT Agent from 13a

Polystyrene seed was synthesized in the same manner as in Example 13b. The latex has 10% solids with an average particle size of 6 nm as measured by dynamic light scattering (Zetasizer, Malvern Instrument).

### Example 16b. Synthesis of Film Forming Poly(Methyl Methacrylate-Co-Butyl Acrylate)/Polystyrene Non-Core-Shell Polymer Particles Using Seed Latex from 16a

Latex from Example 16a (100 g) was added to a 500 mL round bottom flask containing 4,4′-azobisisobutyronitrile (AIBN) (0.24 g) which was then followed by an addition of divinyl benzene (2.4 g) and ethanol (1 g). The flask was subsequently sealed and purged with nitrogen for 10 minutes. The whole flask was then immersed in an oil bath with a temperature setting of 70° C. and was magnetically stirred. After 1 hour of heating, a deoxygenated methyl methacrylate (MMA)/butyl acrylate (BA) solution (1:1 by weight) (10 mL, 9.2 g) was injected into the flask, while in the 70° C. oil bath, at a rate of 20 mL/hour. Upon completion of feeding, 3 g of 2% sodium dodecyl sulphate (SDS) solution was added. Another amount of deoxygenated methyl methacrylate (MMA)/butyl acrylate (BA) solution (1:1 by weight) (40 mL, 36.7 g) was injected into the flask, while in the 70° C. oil bath, at a rate of 20 mL/hour. The heating was continued overnight to produce yellow latex. After filtering with 80 micron mesh, the final latex had 35.3% solids. Particle sizes of 74 nm were measured by dynamic light scattering (Zetasizer, Malvern Instrument).

### Example 16c. Dispersion and Encapsulation of Omyacarb 10 Using Non-Core-Shell Poly(Methyl Methacrylate-Co-Butyl Acrylate)/Polystyrene Particles from 16b

Janus particle latex from Example 16b (20 g) and Omyacarb 10 (30.0 g, Omya Australia) was mixed in a 150 mL beaker. The mixture was further blended for 10 minutes using a mechanical stirrer at 1500 rpm to produce a viscous white dispersion. A small sample (1 g) was dispersed in water (2 mL), centrifuged to remove the supernatant. The process was repeated one more time to totally remove un-adsorbed non-core-shell polymer particles from the Calcite particles. By SEM, the sample was found to contain polymer encapsulated Calcite.

### Example 17. Non-Core-Shell Polymer Particles from Steric Stabilized Seed Latex Containing No Charge

### Example 17a. Preparation of a Poly-[(Butyl Acrylate)ₘ-Block-(Acrylamide)ₙ] Macro-RAFT Agent with m^{≈5} and n^{≈30} Using 2-Amino-1-Methyl-2-Oxoethyl Butyl Trithiocarbonate

2-amino-1-methyl-2-oxoethyl butyl trithiocarbonate (1.2 g, 5 mmol), 2,2′-azobisisobutyronitrile (AIBN) (0.09 g, 0.6 mmol), acrylamide (10.6 g, 150 mmol), in water (15 g) and dioxane (15 g) was prepared in a 100 mL round bottom flask. This was stirred magnetically and purged with nitrogen for 10 minutes. The flask was then heated at 70° C. for 4 hours under constant stirring. To this polymer solution, butyl acrylate (3.2 g, 25 mmol) and AIBN (0.1 g, 0.6 mmol) was added. The flask was again sealed, purged with nitrogen for 10 minutes and further heated for another 3 hours under continuous magnetic stirring. The final copolymer solution had 39.6% solids.

### Example 17b. Synthesis of Crosslinked Polystyrene Seed Latex Using Macro-RAFT Agent from 17a

In a 150 mL round bottom flask, macro-RAFT solution from Example 17a (5.0 g) was dispersed in water (100.0 g) to yield a yellow dispersion. To this dispersion, ethanol (1.6 g) was added and thoroughly mixed. Styrene (0.8 g), divinyl benzene (DVB, 0.2 g) and AIBN initiator (0.06 g) was added then emulsified by magnetic stirring. The emulsion was sealed, sparged with nitrogen for 10 minutes. The whole flask was then immersed in an oil bath with a temperature setting of 70° C. and was magnetically stirred. The heating was carried out for 2 hours to produce yellow latex containing a small amount of polymer aggregates.

The aggregates were subsequently removed by filtering using 80-micron nylon mesh, yielding semi-transparent yellow latex with 1.5% solids. Particle sizes of 24 nm were measured by dynamic light scattering (Zetasizer, Malvern Instrument).

### Example 17c. Synthesis of Film Forming Non-Core-Shell Poly(Methyl Methacrylate-Co-Butyl Acrylate)/Polystyrene Particles Using Seed Latex from 17b

Latex from Example 17b (25 g) was added to a 100 mL round bottom flask containing ammonium persulfate (APS) (0.04 g), water (25 g) and sodium dodecyl sulfate (SDS) (0.015 g). The flask was subsequently sealed and purged with nitrogen for 10 minutes. The whole flask was then immersed in an oil bath with a temperature setting of 70° C. and was magnetically stirred. A deoxygenated methyl methacrylate (MMA)/butyl acrylate (BA) solution (1:1 by weight) (5 mL, 4.6 g) was injected into the flask, while in the 70° C. oil bath, at a rate of 5 mL/hour. Upon completion of feeding the heating was continued overnight to produce yellow latex. After filtering with 80 micron mesh, the final latex had 8.5% solids. Particle sizes of 65 nm were measured by dynamic light scattering (Zetasizer, Malvern Instrument).

### Example 17d. Dispersion and Encapsulation of Omyacarb 10 Using Non-Core-Shell Poly(Methyl Methacrylate-Co-Butyl Acrylate)/Polystyrene Particles from 17c

Non-core-shell polymer particle latex from Example 17c (4 g) and Omyacarb 10 (0.5 g, Omya Australia) was mixed in a 15 mL vial by a magnetic stirrer. A small sample (1 g) was dispersed in water (2 mL), centrifuged to remove the supernatant. The process was repeated one more time to totally remove un-adsorbed non-core-shell polymer particles from the Calcite particles. The sample was then redispersed in water by simple mixing. By SEM, the sample was found to contain polymer encapsulated Calcite.

### Example 17e. Dispersion and Encapsulation of Titanium Dioxide R706 (Chemours) Using Non-Core-Shell Poly(Methyl Methacrylate-Co-Butyl Acrylate)/Polystyrene Particles from 17c

Non-core-shell polymer particle latex from Example 17c (4 g), water (4 g) and Titanium dioxide R706 (0.2 g, Chemours) was mixed in a 15 mL vial by a magnetic stirrer. The dispersion was thoroughly dispersed by sonication for 1 minute using an ultrasonic probe (Vibra-Cell Ultrasonic Processor, Sonics and Materials, Inc.). A small sample (1 g) was dispersed in water (2 mL), centrifuged to remove the supernatant. The process was repeated one more time to totally remove un-adsorbed non-core-shell polymer particles from the Titanium dioxide particles. The pigment was then redispersed in water by simple mixing. By SEM, the sample was found to contain polymer encapsulated Titanium dioxide.

### Example 18. Non-Core-Shell Polymer Particles from Steric Stabilized Seed Latex Containing No Charge and Film Forming Un-Crosslinked Polymer Region Containing Acidic Monomer

### Example 18a. Synthesis of Film Forming Non-Core-Shell Poly(Methyl Methacrylate-Co-Butyl Acrylate-Co-Methacrylic Acid)/Polystyrene Particles Using Seed Latex from 17b

Film forming non-core-shell particle latex was synthesized in the same manner as in Example 17c using latex from Example 17b (25 g), APS (0.03 g), water (25 g), SDS (0.02 g) and MMA/BA/MAA monomer mixture (5 mL, 4.6 g, MMA/BA/MAA is 50/50/4 by weight, MAA at 3.8%) feed rate at 5 mL/hour. The final latex had 9.3% solids and contained particle with an average size of 54 nm as measured by dynamic light scattering (Zetasizer, Malvern Instrument).

### Example 18b. Dispersion and Encapsulation of Omyacarb 10 Using Non-Core-Shell Poly(Methyl Methacrylate-Co-Butyl Acrylate)/Polystyrene Particles from 18a

Non-core-shell polymer particle latex from Example 18a was used to disperse and encapsulate Omyacarb 10 in the same manner as in Example 17d. By SEM, the sample was found to contain polymer encapsulated Calcite.

### Example 18c. Dispersion and Encapsulation of Titanium Dioxide R706 (Chemours)

Using Non-Core-Shell Poly(Methyl Methacrylate-Co-Butyl Acrylate)/Polystyrene Particles from 18a

Non-core-shell polymer particle latex from Example 18a was used to disperse and encapsulate Titanium dioxide R706 (Chemours) in the same manner as in Example 17e. By SEM, the sample was found to contain polymer encapsulated Titanium dioxide.

### Example 19. Polymer Coating Using Non-Core-Shell Polymer Particles

### Example 19a. Synthesis of Film Forming Non-Core-Shell Poly(Methyl Methacrylate-Co-Butyl Acrylate)/Polystyrene Particles

Seed latex was synthesized in the same manner as in Example 13b. Film forming non-core-shell particle latex was then synthesized as in Example 13c. The final latex had 35% solids and contained particle with an average size of 61 nm as measured by dynamic light scattering (Zetasizer, Malvern Instrument).

### Example 19b. Dispersion and Encapsulation of Dry Yeast (Tandaco) Using Non-Core-Shell Poly(Methyl Methacrylate-Co-Butyl Acrylate)/Polystyrene Particles from 19a

Non-core-shell polymer particle latex from Example 19a (5 g) was diluted with water (5 g) then used to disperse and encapsulate Tandaco dry yeast (1 g) by simple mixing. By SEM, the sample was found to contain polymer coated yeast even after water washing.

### Example 19c. Dispersion and Encapsulation of Triphenyl Phosphate Fire Retardant (Sigma Aldrich) Using Non-Core-Shell Poly(Methyl Methacrylate-Co-Butyl Acrylate)/Polystyrene Particles from 19a

Fire retardant triphenyl phosphate pellets were reduced to powder using a blender. Non-core-shell polymer particle latex from Example 19a (5 g) was diluted with water (5 g) then used to disperse and encapsulate the fire retardant (1 g) by sonication for 1 minute. By SEM, the sample was found to contain polymer coated fire-retardant particles.

### Example 19d. Polymer Coating of Fungicide Benzisithiazolinone (BIT) (Sigma Aldrich) Using Non-Core-Shell Poly(Methyl Methacrylate-Co-Butyl Acrylate)/Polystyrene Particles from 19a

Benzisothiazolinone (1.0 g) was dispersed in Janus particle latex from Example 19a (21.3 g) by stirring using a mechanical stirrer at 500 rpm for 5 min. After adding 10 g of DI water, the mixture was further mixed for 10 min using a mechanical stirrer at 1500 rpm to produce a white dispersion. The dispersion was sonicated for 1 min using an ultrasonic probe Vibra-Cell Ultrasonic Processor (Sonics and Materials, Inc.). Sodium Dodecyl Sulfate (SDS) (0.05 g) was then added to the dispersion followed by three min of ultrasonication to produce a white stable dispersion. By SEM, the final sample was found to contain polymer encapsulated BIT particle.

### Example 20. Polymer Coating of Using Fluorescent Non-Core-Shell Polymer Particles

### Example 20a. Synthesis of 15% Fluorescent Film Forming Non-Core-Shell Poly(Methyl Methacrylate-Co-Butyl Acrylate-Co-Methacrylic Acid)/Polystyrene Particles

Seed latex was synthesized in the same manner as in Example 1b. Fluorescent film forming non-core-shell particle latex was then synthesized as in Example 1d with an exception that fluorescent monomer, pyrene methyl methacrylate (0.1 g) was added with DVB (1.2 g) during the crosslinking step. The final latex had 15% solids and contained particle with an average size of 40 nm as measured by dynamic light scattering (Zetasizer, Malvern Instrument). It was observed to be fluorescent under the UV light.

### Example 20b. Synthesis of 32% Fluorescent Film Forming Non-Core-Shell Poly(Methyl Methacrylate-Co-Butyl Acrylate)/Polystyrene Particles

Same seed latex in Example 20a was used for the non-core-shell particle synthesis. Seed latex from Example 20a (200 g) was added to a 1 L round bottom flask containing 4,4′-azobis(4-cyanovaleric acid) (V501) (0.3 g) which was then followed by an addition of divinyl benzene (2.4 g) and pyrene methyl methacrylate (0.2 g). The flask was subsequently sealed and purged with nitrogen for 10 minutes. The whole flask was then immersed in an oil bath with a temperature setting of 70° C. and was magnetically stirred. After 1 hour of heating, a deoxygenated methyl methacrylate (MMA)/butyl acrylate (BA) solution (1:1 by weight) (80 mL, 75 g) was injected into the flask, while in the 70° C. oil bath, at a rate of 80 mL/hour. Half way through the feeding, 6 g of 2% sodium dodecyl sulphate (SDS) solution was added. The heating was continued overnight to produce yellow latex. After filtering with 80 micron mesh, the final latex had 32% solids. Particle sizes of 43 nm were measured by dynamic light scattering (Zetasizer, Malvern Instrument). The latex was found to be fluorescent under the UV light.

### Example 20c. Dispersion and Encapsulation of Heliogen Blue Pigment L7081D (BASF) Using Non-Core-Shell Poly(Methyl Methacrylate-Co-Butyl Acrylate)/Polystyrene Particles from Example 20a and Free Radical Emulsion Polymerization

Non-core-shell polymer particle latex from Example 20a (5 g) was diluted with water (5 g), ethanol (0.5 g) then used to disperse and encapsulate the blue pigment (0.2 g) by sonic bath (10 minutes) and ultrasonication (1 min).

Polymer shell thickness was increased by free radical emulsion polymerization using the following procedure. In a 50 mL round bottom flask containing 0.03 g V501 initiator, 5 g of the above blue pigment latex was added with water (15 g) and SDS solution (1 g 2% SDS). The flask was subsequently sealed and purged with nitrogen for 10 minutes. The whole flask was then immersed in an oil bath with a temperature setting of 70° C. and was magnetically stirred. A deoxygenated methyl methacrylate (MMA)/butyl acrylate (BA) solution (10:1 by weight) (2 mL, 1.9 g) was injected into the flask, while in the 70° C. oil bath, at a rate of 1 mL/hour. Upon completion of feeding, the heating was continued overnight to produce blue latex. After filtering, the final latex had 10.3% solids and an average particle size of 129 nm.

### Example 20d. Dispersion and Encapsulation of Multiwalled Carbon Nanotubes Using Non-Core-Shell Poly(Methyl Methacrylate-Co-Butyl Acrylate)/Polystyrene Particles from Example 20a

Non-core-shell polymer particle latex from Example 20a (5 g) was diluted with water (5 g), ethanol (0.5 g) then used to disperse and encapsulate the multiwalled carbon nanotubes (0.05 g) by ultrasonication (1 min). After addition of SDS (0.01 g), the dispersion was again subjected to ultrasonication again for 1 minute to produce polymer encapsulated multiwalled carbon nanotubes.

### Example 20e. Dispersion and Encapsulation of Omyacarb 10 Using Fluorescent Film Forming Poly(Methyl Methacrylate-Co-Butyl Acrylate)/Polystyrene Non-Core-Shell Particles from Example 20b. BASF Acronal Eco 7603 Latex was Used as a Binder

Polymer coating of Omyacarb 10 extender using UV fluorescent non-core-shell particle from Example 20b was carried out in the same manner as in Example 14. After coating, the pigment was observed to be fluorescent under the UV light. The coated Omyacarb 10 was then blended with BASF Acronal Eco 7603 with the procedure described in Example 14. Polymer film on Leneta card from this mixture was subjected to the same Blue food dye stain resistant test. Most of the stain was found to be easily removed.

### Example 21. Multilobed Film Forming Non-Core-Shell Particles for Polymer Coating

### Example 21a. Preparation of a Poly-[(Sodium Styrene Sulfonate)-Co-(Acrylic Acid)]Macro-RAFT Agent Containing an Average of 15 Monomer Units Per Chain in a Molar Ratio of 1:2 Using 2-{[(Butylsulfanyl)Carbonothioyl]Sulfanyl} Propanoic Acid

2-{[(butylsulfanyl)carbonothioyl]sulfanyl} propanoic acid (1.8 g, 8 mmol), V501 initiator (0.11 g, 0.4 mmol), sodium styrene sulfonate (StS) (7.8 g, 38 mmol), acrylic acid (5.4 g, 75 mmol), in dioxane (15 g) and water (15 g) was prepared in a 100 mL round bottom flask. This was stirred magnetically and purged with nitrogen for 10 minutes. The flask was then heated at 80° C. for 4 hours under constant stirring. The final copolymer solution had 38% solids.

### Example 21b. Synthesis of Poly(Butyl Acrylate) Seed Latex Using Macro-RAFT Agent from Example 21a

In a 1 L beaker, macro-RAFT solution from Example 21a (10.0 g) was dispersed in water (250.0 g) to yield a yellow solution. Ammonium hydroxide (25% solution in water) was added to the macro-RAFT solution to raise the pH to 7.5 producing a clear yellow solution.

The solution was transferred to a 1 L round bottom flask containing ammonium persulfate (APS) (0.15 g) and SDS (0.15 g) which was subsequently sealed and purged with nitrogen for 10 minutes. The whole flask was then immersed in an oil bath with a temperature setting of 70° C. and was magnetically stirred. A deoxygenated butyl acrylate (25 mL, 22.3 g) was injected into the flask, while in the 70° C. oil bath, at a rate of 10 mL/hour. Upon completion of feeding, the heating was continued overnight to produce yellow latex with 9.3% solids. Particle sizes of 57 nm were measured by dynamic light scattering (Zetasizer, Malvern Instrument).

### Example 21c. Synthesis of Film Forming Poly(Methyl Methacrylate-Co-Butyl Acrylate)/Poly(Butyl Acrylate) Non-Core-Shell Particles Using Seed Latex from 21b

Latex from Example 21b (250 g) was added to a 1 L round bottom flask containing APS (0.15 g) which was then followed by an addition of divinyl benzene (5 g). The flask was subsequently sealed and purged with nitrogen for 10 minutes. The whole flask was then immersed in an oil bath with a temperature setting of 70° C. and was magnetically stirred. After 1 hour of heating, a deoxygenated methyl methacrylate (MMA)/butyl acrylate (BA) solution (1:1 by weight) (140 g) was injected into the flask, while in the 70° C. oil bath, at a rate of 120 mL/hour. Upon completion of feeding, the heating was continued overnight to produce yellow latex. After filtering with 80 micron mesh, the final latex had 37.2% solids. Particle sizes of 205 nm were measured by dynamic light scattering (Zetasizer, Malvern Instrument).

### Example 21d. Dispersion and Encapsulation of Omyacarb 10 Using Multilobed Non-Core-Shell Particles from 21c. BASF Acronal Eco 7603 Latex was Used for Film Forming

Polymer coating of Omyacarb 10 using non-core-shell polymer particles from Example 21c, polymer film containing it on Leneta cards and blue food dye stain removal tests were carried out as in Example 14. It was found that most of blue food dye stain could be removed.

### Example 22. Hollow Non-Core-Shell Particles for Polymer Coating

### Example 22a. Hollow Particle Seed Latex

Macro-RAFT solution from Example 6a (9.4 g) was mixed with styrene (45 g) and AIBN (0.36 g) in a 250 mL beaker. To this macro-RAFT solution, a solution of water (18 g) and sodium hydroxide (0.6 g) was added while the solution was stirred at 1500 rpm using an overhead mixer (Labortechnik, IKA) producing a viscous white emulsion. To this emulsion, extra water (120 g) was added in drop wise while the solution was stirred at 1500 rpm producing a white emulsion. It was transferred to a 250 mL round bottom flask which was sealed and subsequently purged with nitrogen for 15 min. The whole flask was immersed in an oil bath with a temperature setting of 80° C. and the heating was carried out for 3 hours under constant magnetically stirring. The final latex was white and stable, containing particles about 622 nm in diameter (DLS, Malvern Instruments Ltd) with 30.4% solids. Transmission electron microscopy showed that the latex contains polymeric hollow particles.

### Example 22b. Poly(MMA-Co-BA)/Polystyrene Hollow Non-Core-Shell Particles Using Hollow Seed from 22a

Hollow seed latex from Example 22a (20.0 g) was mixed with water (80.0 g), DVB (1.3 g) and V501 (0.06 g) in a 250 mL round bottom flask. The flask was subsequently sealed and purged with nitrogen for 10 minutes. The whole flask was then immersed in an oil bath with a temperature setting of 70° C. and was magnetically stirred. After 1 hour of heating, deoxygenated methyl methacrylate (MMA)/butyl acrylate (BA) solution (1:1 by weight) (10 mL, 9.2 g) was injected into the flask, while in the 70° C. oil bath, at a rate of 10 mL/hour. Upon completion of feeding, the heating was continued for 2 hours to produce white latex. The final latex had 15.3% solids with an average particle size of 393 nm (Zetasizer, Malvern Instrument) and was found to contain hollow non-core-shell particles by TEM. The latex formed white opaque film upon drying.

### Example 22c. Dispersion and Encapsulation of Omyacarb 10 Using Non-Core-Shell Hollow Particles from 22b

Non-core-shell polymer particle latex from Example 22b (5 g) was mixed with water (5 g) and latex from Example 19a (2 g) then used to disperse and encapsulate Omyacarb 10 (1 g) by simple mixing. By SEM, the sample was found to contain polymer coated calcite even after water washing. The final latex formed opaque film up on drying.

### Example 23. Rod-Like Non-Core-Shell Particles for Polymer Coating

### Example 23a. Rod-Like Seed Latex

Macro-RAFT solution from Example 6a (7 g) was mixed with styrene (14 g) and AIBN (0.12 g) in a 250 mL beaker. To this macro-RAFT solution, a solution of water (6 g) and sodium hydroxide (0.4 g) was added while the solution was stirred at 1500 rpm using an overhead mixer (Labortechnik, IKA) producing a viscous white emulsion. To this emulsion, extra water (54 g) was added in drop wise while the solution was stirred at 1500 rpm producing a white emulsion. It was transferred to a 250 mL round bottom flask which was sealed and subsequently purged with nitrogen for 10 min. The whole flask was immersed in an oil bath with a temperature setting of 80° C. and the heating was carried out for 3 hours under constant magnetically stirring. The final latex was white and stable, containing particles about 78 nm in diameter (DLS, Malvern Instruments Ltd) with 26.9% solids. Transmission electron microscopy showed that the latex contains polymeric rod-like particles.

### Example 23b. Synthesis of Rod-Like Non-Core-Shell Particles Using Seed from Example 23a

Rod-like seed latex from Example 23a (20.0 g) was mixed with water (80.0 g), DVB (0.6 g), SDS (0.06) and V501 (0.06 g) in a 250 mL round bottom flask. The flask was subsequently sealed and purged with nitrogen for 10 minutes. The whole flask was then immersed in an oil bath with a temperature setting of 70° C. and was magnetically stirred. After 1 hour of heating, deoxygenated methyl methacrylate (MMA)/butyl acrylate (BA) solution (1:1 by weight) (5 mL, 4.6 g) was injected into the flask, while in the 70° C. oil bath, at a rate of 10 mL/hour. Upon completion of feeding, the heating was continued for 4.5 hours to produce white latex. The final latex had 9.6% solids with an average particle size of 79 nm (Zetasizer, Malvern Instrument). The latex was found to contain rod-like non-core-shell particles by TEM.

### Example 23c. Dispersion and Encapsulation of Omyacarb 10 Using Non-Core-Shell Hollow Particles from Example 23b

Non-core-shell polymer particle latex from Example 23b (5 g) was mixed with water (5 g) and latex from Example 19a then used to disperse and encapsulate Omyacarb 10 (1 g) by simple mixing. By SEM, the sample was found to contain polymer coated calcite.

### Example 24. Pigmented Non-Core-Shell Particles for Polymer Coating

### Example 24a. Preparation of a Poly(Butyl Acrylate-Co-Acrylic Acid) Macro-RAFT Agent Using 2-{[(Butylsulfanyl)Carbonothioyl]Sulfanyl}Propanoic Acid

A solution of 2-{[(butylsulfanyl)carbonothioyl]sulfanyl}propanoic acid (1.24 g), 2,2′-azobisisobutyronitrile (0.05 g), acrylic acid (3.80 g), butyl acrylate (5.04 g) in dioxane (10.0 g) was prepared in a 50 mL round bottom flask. This was stirred magnetically and sparged with nitrogen for 10 minutes. The flask was then heated at 70° C. for 12 hrs under constant stirring. The final copolymer solution has 52.7% solids.

### Example 24b. Poly(Methyl Methacrylate-Co-Butyl Acrylate) Encapsulated Phthalocyanine Blue Pigment (Heliogen Blue L6900, BASF) Seed Latex

A solution containing macro RAFT from Example 24a (1 g), ethylene glycol (20 g) and methanol (3 g) was prepared in a 50 ml beaker. The solution was transferred to a water-jacketed milling vessel (Dispermat™ AE 3 C laboratory dissolver fitted with an APS 250 milling system, VMA-Getzmann) containing phthalocyanine blue pigment (5 g) and 1 mm in diameter glass beads (101 g). The bath jacket temperature was maintained at 20° C. The milling was initially at 1000 rpm for 5 mins then ramped up to 5000 rpm for 10 mins to produce a viscous blue dispersion. To this dispersion, a base solution containing water (10 g) and sodium hydroxide (0.1 g) was added while the milling was continued for another 10 mins to produce a blue dispersion. At the end of the milling, another portion of water (50 g) was mixed with the pigment dispersion. Foam and glass beads were then separated from the dispersion using a plastic mesh. It was further sonicated for 10 minutes then filtered to produce a well dispersed pigment. The pigment dispersion was transferred into a 100 ml round bottom flask containing 4,4′-azobis(4-cyanovaleric acid) (0.05 g). The flask was sealed, sparged with nitrogen for 10 mins, placed in an oil bath maintained at 70° C. and stirred magnetically. A deoxygenated solution of butyl acrylate (BA) and methyl methacrylate (MMA) (1/10) (5 mL, 4.6 g) was injected into the flask at a rate of 2.5 ml/hour and the reaction was left running overnight. After filtering, the final latex had 10.4% solids and contained polymer encapsulated blue pigment. The latex had an average particle diameter of 209 nm as measured using dynamic laser light scattering (Zetasizer, Malvern Instruments Ltd).

### Example 24c. Pigmented Non-Core-Shell Particles Using Seed from 24b

Polymer encapsulated blue pigment latex from Example 24a (20.0 g) was mixed with water (80.0 g), DVB (0.35 g), SDS (0.03 g) and V501 (0.06 g) in a 250 mL round bottom flask. The flask was subsequently sealed and purged with nitrogen for 10 minutes. The whole flask was then immersed in an oil bath with a temperature setting of 70° C. and was magnetically stirred. After 1 hour of heating, deoxygenated methyl methacrylate (MMA)/butyl acrylate (BA) solution (1:1 by weight) (10 mL, 9.2 g) was injected into the flask, while in the 70° C. oil bath, at a rate of 10 mL/hour. Upon completion of feeding, the heating was continued for 5 hours to produce blue latex. The final latex had 10.1% solids with an average particle size of 304 nm (Zetasizer, Malvern Instrument) and was found to contain pigmented non-core-shell particles by TEM. The latex formed blue film upon drying.

### Example 24d. Dispersion and Encapsulation of Omyacarb 10 Using Pigmented Non-Core-Shell Particles from Example 24c

Pigmented non-core-shell polymer particle latex from Example 24c (5 g) was mixed with water (5 g) then used to disperse and encapsulate Omyacarb 10 (1 g) by simple mixing. By SEM, the sample was found to contain polymer coated calcite even after water washing. The coated calcite displayed blue colour.

### Example 24e. Polymer Coating of Terracotta Using Pigmented Non-Core-Shell Particles from 24c

Pigmented non-core-shell polymer particle latex from Example 24c (5 g) was used to wet surface of a terracotta piece (3×3 cm). Upon drying, the polymer coated terracotta displayed blue colour.

### Example 24f. Polymer Coating of Concrete Using Pigmented Non-Core-Shell Particles from 24c

Pigmented non-core-shell polymer particle latex from Example 24c (5 g) was used to wet surface of a concrete piece (5×3×1 cm). Upon drying, the polymer coated concrete displayed blue colour.

### Example 25. Polymer Coating of Organic Compounds

### Example 25a. Polymer Coating of 2,4,6-Tribromophenol Using Film Forming Non-Core-Shell Particle Latex from Example 13c

2,4,6-tribromophenol (0.5 g) was dispersed in non-core-shell particle latex from Example 13c (5 g) diluted with 7.2 g of DI water by magnetically stirring. After adding 0.67 g of ethanol, the mixture was further magnetically mixed for 5 min to produce a dispersion. The dispersion was sonicated for 2 min using an ultrasonic probe Vibra-Cell Ultrasonic Processor (Sonics and Materials, Inc.). Sodium Dodecyl Sulfate (SDS) (0.033 g) was then added to the dispersion followed by 30 seconds of ultrasonication to produce a stable dispersion. By SEM, the final sample was found to contain polymer encapsulated 2,4,6-tribromophenol particle.

### Example 25b. Polymer Coating of Azobisisobutyronitrile (AIBN) Using Film Forming Non-Core-Shell Particle Latex from Example 13c

AIBN (0.02 g) was dispersed in non-core-shell particle latex from Example 13c (3.5 g) by mixing using a spatula. After adding 0.67 g of ethanol, the dispersion was further mixed for 2 minutes before the coated AIBN particle was washed twice with DI water using a bench-top centrifuge (9000 rpm and 45 seconds) to remove the excess latex particle. The washed particle was then dried under reduced pressure to yield a dried powder. By SEM, the final sample was found to contain polymer encapsulated AIBN particle.

### Example 26. Non-Core-Shell Particles from Sodium 2-(2-(((Butylthio)Carbonothioyl)Thio)Propanamido)Ethane-1-Sulfonate RAFT Agent

### Example 26a. Synthesis of Poly(Butyl Acrylate) Seed Latex Using Sodium 2-(2-(((Butylthio)Carbonothioyl)Thio)Propanamido)Ethane-1-Sulfonate RAFT Agent

In a 250 mL round bottom flask, sodium 2-(2-(((butylthio)carbonothioyl)thio)propanamido)ethane-1-sulfonate RAFT agent (0.25 g), SDS (0.06 g), V501 (0.06 g) was dispersed in water (100.0 g) to yield a yellow dispersion. Ammonium hydroxide (25% solution in water) was added to the RAFT solution to raise the pH to 9.5. Butyl acrylate (BA, 10.0 g) was added to this bottom flask which was subsequently sealed and purged with nitrogen for 10 minutes. The whole flask was then immersed in an oil bath with a temperature setting of 70° C. and was magnetically stirred. The flask was heated over 3 hours to produce semi-transparent yellow latex with 7.6% solids. Particle sizes of 34 nm were measured by dynamic light scattering (Zetasizer, Malvern Instrument).

### Example 26b. Synthesis of Film Forming Poly(Methyl Methacrylate-Co-Butyl Acrylate)/Polystyrene Non-Core-Shell Particles Using Seed Latex from 26a

Latex from Example 26a (20 g) was added to a 100 mL round bottom flask containing 4,4′-azobis(4-cyanovaleric acid) (V501) (0.06 g) which was then followed by an addition of divinyl benzene (0.25 g). The flask was subsequently sealed and purged with nitrogen for 10 minutes. The whole flask was then immersed in an oil bath with a temperature setting of 70° C. and was magnetically stirred. After 1 hour of heating, a deoxygenated methyl methacrylate (MMA)/butyl acrylate (BA) solution (1:1 by weight) (10 mL, 9.2 g) was injected into the flask, while in the 70° C. oil bath, at a rate of 10 mL/hour. The heating was continued for another 3 hours to produce yellow latex. After filtering, the final latex had 18.1% solids. Particle sizes of 82 nm were measured by dynamic light scattering (Zetasizer, Malvern Instrument).

### Example 26c. Dispersion and Encapsulation of Omyacarb 10 Using Non-Core-Shell Particles from 26b

Non-core-shell polymer particle latex from Example 26b (5 g) was mixed with water (5 g) then used to disperse and encapsulate Omyacarb 10 (1 g) by simple mixing.

### Example 27. Polymer Coating of Biocides

### Example 27a. Dispersion and Encapsulation of Triasulfuron Using Poly(MMA-Co-BA)/Polystyrene Non-Core-Shell Particles from 1d

Non-core-shell particle latex from Example 1d (10.57 g) and ASE-60 solution (2.8%, pH 7.5, 25.52 g) was added and mixed for 1 minute in a 50 mL vial. To this latex, Triasulfuron (0.97 g) was added and mixed under constant magnetic stirring to produce a white dispersion. The dispersion was further dispersed for 1 minute using an ultrasonic probe Vibra-Cell Ultrasonic Processor (Sonics and Materials, Inc.). After the sonication, 0.06 g of Sodium Dodecyl Sulfate (SDS) was added to the dispersion. This was followed by another minute of ultrasonication to produce a white stable dispersion. By TEM and SEM, the final sample was found to contain polymer encapsulated Triasulfuron particles.

### Example 27b. Dispersion and Encapsulation of Sedaxane Using Poly(MMA-Co-BA)/Polystyrene Non-Core-Shell Particles from 1d

Non-core-shell particle latex from Example 1d (10.11 g) and ASE-60 solution (2.8%, pH 7.5, 25.33 g) was added and mixed for 1 minute in a 50 mL vial. To this latex, Sedaxane (1.03 g) was added and mixed under constant magnetic stirring to produce a brownish dispersion. The dispersion was further dispersed for 1 minute using an ultrasonic probe Vibra-Cell Ultrasonic Processor (Sonics and Materials, Inc.). After the sonication, 0.06 g of Sodium Dodecyl Sulfate (SDS) was added to the dispersion. This was followed by another minute of ultrasonication to produce a brownish stable dispersion. By TEM and SEM, the final sample was found to contain polymer encapsulated Sedaxane particles.

### Example 27c. Dispersion and Encapsulation of Chlorothalonil Using Poly(MMA-Co-BA)/Polystyrene Non-Core-Shell Particles from 1d

Non-core-shell particle latex from Example 1d (10.06 g) and ASE-60 solution (2.8%, pH 7.5, 25.07 g) was added and mixed for 1 minute in a 50 mL vial. To this latex, Chlorothalonil (1.15 g) was added and mixed under constant magnetic stirring to produce a white dispersion. The dispersion was further dispersed for 1 minute using an ultrasonic probe Vibra-Cell Ultrasonic Processor (Sonics and Materials, Inc.). After the sonication, 0.06 g of Sodium Dodecyl Sulfate (SDS) was added to the dispersion. This was followed by another minute of ultrasonication to produce a white stable dispersion. By TEM and SEM, the final sample was found to contain polymer encapsulated Chlorothalonil particles.

### Example 27d. Dispersion and Encapsulation of Cyprodinil Using Poly(MMA-Co-BA)/Polystyrene Non-Core-Shell Particles from 1d

Non-core-shell particle latex from Example 1d (10.2 g) and ASE-60 solution (2.8%, pH 7.5, 25.4 g) was added and mixed for 1 minute at 900 rpm using a mechanical overhead stirrer in a 50 mL vial. To this latex, Cyprodinil (0.92 g) was added and mixed using ultra-turrax for 2 min at highest speed to produce a white dispersion. The dispersion was further dispersed for 2 min using an ultrasonic probe Vibra-Cell Ultrasonic Processor (Sonics and Materials, Inc.). After the sonication, 0.06 g of Sodium Dodecyl Sulfate (SDS) was added to the dispersion. This was followed by 2 min of ultrasonication to produce a white stable dispersion. By TEM and SEM, the final sample was found to contain polymer encapsulated Cyprodinil particles.

### Example 27e. Dispersion and Encapsulation of Thiamethoxam Using Poly(MMA-Co-BA)/Polystyrene Non-Core-Shell Particles from 1d

Non-core-shell particle latex from Example 1d (10.04 g) and ASE-60 solution (2.8%, pH 7.5, 25.13 g) was added and mixed for 1 minute in a 50 mL vial. To this latex, Thiamethoxam (1.25 g) was added and mixed under constant magnetic stirring to produce a brownish dispersion. The dispersion was further dispersed for 2 min using an ultrasonic probe Vibra-Cell Ultrasonic Processor (Sonics and Materials, Inc.). After the sonication, 0.06 g of Sodium Dodecyl Sulfate (SDS) was added to the dispersion. This was followed by another minute of ultrasonication to produce a white stable dispersion. By TEM and SEM, the final sample was found to contain polymer encapsulated Thiamethoxam particles.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A method which uses non-core-shell polymer particles to form polymer film on a pre-formed solid substrate surface, said non-core-shell polymer particles comprising two covalently coupled polymer regions of different molecular composition, wherein (a) one of the two polymer regions is a crosslinked RAFT polymer region and the other polymer region is a film forming polymer region, (b) the crosslinked RAFT polymer region comprising particle aggregation prevention means selected from one or more of charged and steric stabilising functionality, and (c) the film forming polymer region comprising 0-3 wt. % of charged polymerised monomer residues relative to the total amount of polymerised monomer residues present in that region, the method comprising contacting in a liquid the pre-formed solid substrate surface with the non-core-shell polymer particles dispersed in the liquid, wherein the non-core-shell polymer particles adsorb onto the pre-formed solid substrate surface through the film forming polymer region and the film forming polymer regions of the adsorbed non-core-shell polymer particles coalesce to form the polymer film.

2. The method according to claim 1, wherein the pre-formed solid substrate is in the form of pre-formed solid particulate material and the non-core-shell polymer particles form an encapsulating polymer film around the pre-formed solid particulate material.

3. The method according to claim 1, wherein the film forming polymer region comprises no charged polymerised monomer residues.

4. The method according to claim 1, wherein the film forming polymer region does not comprise steric stabilising functionality.

5. The method according to claim 1, wherein the so formed polymer film is a multi-layer polymer film.

6. The method according to claim 1, wherein the liquid in which the non-core-shell polymer particles are dispersed is an aqueous liquid having a pH in the range of 3-5.

7. The method according to claim 1, wherein the non-core-shell polymer particles have a largest average diameter of no more than about 300 nm.

8. The method according to claim 1, wherein the pre-formed solid substrate comprises or is made of pigment or bioactive material.

9. The method according to claim 1, wherein the crosslinked RAFT polymer region comprises one or more voids, particulate material or a combination thereof.

10. The method according to claim 1 further comprising introducing monomer into the liquid and polymerising that monomer so as to increase the thickness of the polymer film.

11. Solid substrate having polymer film adsorbed on a surface thereof, said polymer film comprising a plurality of polymer regions that (i) are different in molecular composition to the polymer film, (ii) are covalently coupled to the polymer film, and (iii) comprise (a) crosslinked RAFT polymer, and (b) particle aggregation prevention means selected from one or more of charged and steric stabilising functionality, wherein said polymer film comprises 0-3 wt. % of charged polymerised monomer residues relative to the total amount of polymerised monomer residues present in the film.

12. The solid substrate according to claim 11, wherein the polymer film comprises no charged polymerised monomer residues.

13. The solid substrate according to claim 11, wherein the polymer film is a multi-layer polymer film.

14. The solid substrate according to claim 11, wherein the crosslinked RAFT polymer region comprises one or more voids, particulate material or a combination thereof.

15. Solid particulate material encapsulated in a polymer film, said polymer film comprising a plurality of polymer regions that (i) are different in molecular composition to the polymer film, (ii) are covalently coupled to the polymer film, and (iii) comprise (a) crosslinked RAFT polymer, and (b) particle aggregation prevention means selected from one or more of charged and steric stabilising functionality, wherein said polymer film comprises 0-3 wt. % of charged polymerised monomer residues relative to the total amount of polymerised monomer residues present in the film.

16. The solid particulate material according to claim 15, wherein the polymer film comprises no charged polymerised monomer residues.

17. The solid particulate material according to claim 15, wherein the polymer film is a multi-layer polymer film.

18. The solid particulate material according to claim 15, wherein the crosslinked RAFT polymer region comprises one or more voids, particulate material or a combination thereof.
